(19) United States
(12) Patent Application Publication
(10) Pub. No.: US 2006/0186624 A1
(43) Pub. Date: Aug. 24, 2006

(54) Accessories for a collapsible rolling caddy

(76) Inventor: Darren Kady, Cornelius, NC (US)

Correspondence Address: Sheldon Parker,;Parker Intellectual Property Law Offices, 536 Pantops Center #234, Charlottesville, VA, 22911, US

(21) Appl. No.: 11/409,663

(22) Filed: Apr. 24, 2006

Related U.S. Application Data
(63) Continuation-in-part of application No. 10/189,085, filed on Jul. 3, 2002.
Application No. 10/189,085 is a continuation-in-part of application No. PCT/US01/41675, filed on Aug. 11, 2001.
(60) Provisional application No. 60/291,548, filed on May 17, 2001.

(51) Int. Cl. B62B 1/00

(52) U.S. Cl. 280/47.18; 280/47.33

(57) ABSTRACT

Improvements to a prior art collapsible wheeled caddy are disclosed to enable the caddy to be used for specialized purposes. A removable lid is attached to the open edge of the caddy through the use of snap locks, Velcro®, magnets, etc. One or more storage members, such as a cup holder, are dimensioned to be recessed within the walls of the caddy. Hangers are configured to interact with the sides of the caddy to accommodate hanging items such as file folders.

### RELATE BACK

This application claims the benefits from and is a Continuation in Part U.S. Ser. No. 10/189,085 filed Jul. 3, 2002, which is a Continuation in Part of PCT Serial No. PCT/US01/41675, Filed Aug. 11, 2001, which is a conversion of Provisional Ser. No. 60/291,548, Filed May 17, 2001, which are incorporated herein as though recited in full.

### BACKGROUND OF THE INVENTION

1. Field of the Invention

The disclosed invention relates to an improved wheeled caddy that enables a user to customize the caddy based on an end use.

2. Brief Description of the Prior Art

Collapsible, wheeled carts have been used for year to carry produce and various items. They have not, however, ever been more than a single large cavity for placing groceries or other items. This does not present a problem when the carts are being used to carry large bulky items, however when used for files or merchandise that requires protection and separation, the prior art carts present problems.

Another problem presented with prior art carts is when stacking items such as brief cases or luggage on top of the cart, there is no built in method of retaining the items onto the cart. The only available method in the prior art is to use separate bungee cords or other tying devices to secure the items. Although this works effectively, the loose cords present a storage problem and easily get lost.

The disclosed cart overcomes these problem by disclosing a collapsible cart with a removable container, file holders and a built in securing cord holder.

### SUMMARY OF THE INVENTION

A collapsible wheeled caddy has been disclosed in the prior art to carry groceries and other items. The wheeled caddy has a front and back panel, vertically hinged side panels, a hinged bottom panel and retractable handles within the back panel. The disclosed improvements enable the caddy to be used for more specialized purposes. The disclosed caddy has a lid that is hingeably attached to a lip extending from the edge of the front panel, thereby enabling the lid to lie adjacent to the front panel when in an open position and adjacent the edge of the caddy when closed. A portion of the front panel of the caddy can be recessed to receive the lid, placing the lid on the same plane as the non-recessed portion of the front panel. To recess the front panel, the extending lip should be appropriately dimensioned. The lid can be a thin cover or have sufficient depth to form a single or multi-compartment container. The lip can be redimensioned to accommodate for the depth of the container in order to enable the container to rotate about 270 degrees. In some embodiments, the lid rests on two or more of the open caddy edges, while in other embodiments the lid rests only on a single edge. Alternatively, the lip can be dimensioned to space the lid from the recess, bringing it in contact with the front panel. The edge of the lid opposing the hinge can have arcs that are dimensioned to accommodate the handles when in the closed position.

The recess can accommodate one or more storage members that have been dimensioned to be affixed within the recess. Alternatively, a storage panel, containing at least one storage member, can be configured to fit within recess. A pair of hangers is configured to interact with the hingeable sides of the caddy. The hangers have a back support configured to lie adjacent the hinged side panels. A top plate is at right angles to the back support and a back panel is at a right angle to the top plate. The dimensioning between the back panel and back support form a snap fit over the hinged side panel edge. The hangers can have L-shaped brackets that extend at a right angle from the back panel. The leg of the L opposing the back panel serves to retain items, such as hanging file jackets, within the bracket. The back panel can, alternatively, continue to the bottom panel. Clips, or other retaining members, can be placed on the back panel to removably affix items to the back panel. An equipment receiving area can be placed in the caddy that has been configured to receive equipment, such as a stapler, and is designed to enable the equipment to be stored and used while in the receiving area.

A support rod can be used to provide support to portions of said lid not lying adjacent an edge of the caddy. The opposing edges of the caddy can be notched to receive the support rod, enabling the lid to remain flush with the edges. One or more section dividers can be placed within the caddy to divide the caddy into one or more smaller sections. Pairs of channels, directly opposing one another, can be incorporated within the mold to receive a divider panel to separate the caddy into rectangular sections. Luggage or other items can be placed on the top of the closed lid with flexible holders, such as retractable belts, can be used to retain the items placed on the lid in position.

A stacking caddy can also be incorporated with the wheeled caddy. The stacking caddy consists of a front panel, a back panel, vertically hinged side panels, hinged bottom panel, and a lid. The back panel has a handle recess that is dimensioned to receive the handles, as well as a handle retaining member to prevent inadvertent removal of the handles from the recess. The lid is hingeably affixed to the front panel edge, lying proximate the front panel when open and adjacent at least one caddy edge when closed. Caddy receiving channels can be placed in the bottom of the stacking caddy that are dimensioned to receive the edges of the wheeled caddy, preventing lateral movement between the stacking caddy and wheeled caddys.

A spacer unit can be used to stack two wheeled, or a wheeled and stacking, caddys. The spacer unit has a top receiving area with wheel wells, alignment prongs, and locking members. The bottom receiving area has a caddy receiving channel dimensioned to receive the top edges of the lower caddy, a handle receiving area and locking members. The bottom receiving area of the spacer unit is placed on a first, bottom, caddy and locked to the bottom caddy. A second, wheeled caddy, is then placed in the top receiving area, and locked to the spacer unit. The spacer unit wheel wells and alignment prongs interact with the top caddy to prevent lateral movement.

A container case can also be affixed to the front or back panels of the caddy. The case has a hinged lid and contains multiple self-leveling containers affixed to a rotatable brace. The rotatable brace folds to bring the containers within the case when the lid is closed and extends the containers in an accessible manner when the lid is open.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is a top view of the disclosed caddy container lid in the open position;

FIG. 2 is perspective view of the open caddy with the container lid lying flush with the front surface;

FIG. 3 is a front view of the two-part hinges for use with the partitioned container top;

FIG. 4 is a rear view of the disclosed caddy having a securing cord recess and recessed pull down storage or cup areas;

FIG. 5 is a side view of the securing cord of FIG. 4 stored within the caddy;

FIG. 6a is a side view of an open single element cup holder;

FIG. 6b is a side view of an alternate embodiment of a double element cup holder;

FIG. 6c is an side view of a hanging double element cup holder;

FIG. 6d is a side view of an alternate embodiment of a single element hanging cup holder;

FIG. 7 is a side view of a small, fold out item holder;

FIG. 8 is a cutaway side view of another embodiment of the partitioned container, partially recessed within the caddy;

FIG. 9 a top view of the base of the caddy with the recessed file holders;

FIG. 10 is a front view of the assembled file holder;

FIG. 11 is an exploded side view of the file holder of FIG. 10;

FIG. 12 is a side view of the assembled file holder of FIG. 10;

FIG. 13 is an alternate embodiment of the container;

FIG. 14 is a rear view of the caddy illustrating the protective bumpers;

FIG. 15 is a side view of a bungee cord holder;

FIG. 16 is a top perspective view of an alternate caddy design with a removable lip;

FIG. 17 is a perspective view of a bungee cord holder to be recessed within the caddy;

FIG. 18 is a perspective view of an alternate one-piece file holder;

FIG. 18A is a perspective view of a one piece file holder having dual hangers;

FIG. 19 is a front view of an alternate attachment method for the container using a flanged container and channels within the caddy;

FIG. 20 is a perspective front view of an embodiment illustrating an alternate hinge design;

FIG. 21 is a perspective front view of the hinge design of FIG. 20 with the container being partially removed;

FIG. 22 is a perspective view of the disclosed caddy with a center hinged, two piece lid;

FIG. 23 is a perspective view of the hinged top of FIG. 22; and

FIG. 24 is a perspective view of an alternative hinge system for the hinged top;

FIG. 25 is a perspective view of the disclosed caddy containing slide in dividers and a non-container detachable lid;

FIG. 26 is a perspective view of the caddy having a non container lid and lid receiving recess;

FIG. 27 is a perspective view of the caddy of FIG. 26 containing pockets within the recessed area;

FIG. 28 is a perspective view of an insert for placement into the caddy;

FIG. 29 is a perspective view of a stackable caddy placed into position on the wheeled caddy;

FIG. 30 is a method of retaining the stacked caddy;

FIG. 31 is a top view of an alternate retaining method for the stackable caddy;

FIG. 32 is a perspective view of a separator to enable wheeled caddys to be stacked;

FIG. 33 is a side view of an exploded perspective view of the single piece hanging folder rails to be snapped onto the caddy side rails;

FIG. 34 is a perspective view of a caddy containing hanging folder rails with hanging file folders placed on the rails;

FIG. 35 is a perspective view of an design for retaining the caddy lid using front channels, with the caddy lid closed;

FIG. 35A is a perspective view of the design of FIG. 35 with the lid open;

FIG. 36 is a top view of an alternate method of retaining the lid using a hinged slide;

FIG. 37 is a perspective view of the disclosed caddy with a slide in attachment panel;

FIG. 38 is a perspective view of a caddy having a side panel, partial lid and support bar;

FIG. 39 is a side view of an alternate embodiment the caddy having container receiving channels;

FIG. 40 is an side view of a container for use with the caddy of FIG. 39;

FIG. 41 is a side view of an alternate container for use with the caddy of FIG. 39;

FIG. 42 is a perspective view of an alternate caddy embodiment having a pull out storage box;

FIG. 43 is a side view of the pull out storage box of FIG. 42

FIG. 44 is a top view of and example of the hinge mechanism for use with the pull out storage box of FIG. 42;

FIG. 45 is a side view of an alternate caddy having front wheels and an angled handle;

FIG. 46 is a side view of a front wheeled caddy having an pull-out handle system;

FIG. 47 is an perspective view of an alternate fold out storage box in an open position;

FIG. 48 is a top view of an alternate design for receiving the lower caddy handles within the top caddy;

FIG. 49 is a top view of an additional design for maintaining the stackable caddies in a stacked position;

FIG. 50 is a top view of an alternate base holder for the storage of file hangers;

FIG. 51 is a top view of the holder for storage files of FIG. 50 with a retaining brace in place;

FIG. 52 is a bottom view of the retaining brace of FIG. 51; and

FIG. 53 is an exploded perspective view of a container having a removable lid.

### DETAILED DESCRIPTION OF THE INVENTION

### Introduction to the Preferred Embodiments

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

The collapsible plastic caddy has been known in the art, however, until the disclosed improvements, the caddy has only been useful for carry groceries or miscellaneous articles. The disclosed improvements enable the caddy to be used for numerous recreational activities, sports or tools, as well as office or business related applications.

### DEFINITIONS

For the purposes herein the term “hinge” refers to any mechanism containing a pivot point that enables items to move in relationship to one another around that pivot point.

For the purposes herein the term “removable hinge” refers to any mechanism containing a pivot point that enables items to move in relationship to one another around that pivot point and provides a mechanism for separating and reaffixing to items.

For the purposes herein the term “securing cord” refers to any elastic or non-elastic cord, manufactured from an appropriate material that can be used to secure an article, or articles, to another article or articles.

For the purposes herein the term “securing mechanism” refers to any device that can secure two items together. This can include, but is not limited to, Velcro®, snaps, buttons, magnets, snap locks where a circular piece on one item snaps into and rotates within a concave piece on the second item, plastic buckles containing any type of release. Velcro® is generically know as a hook and loop fastener.

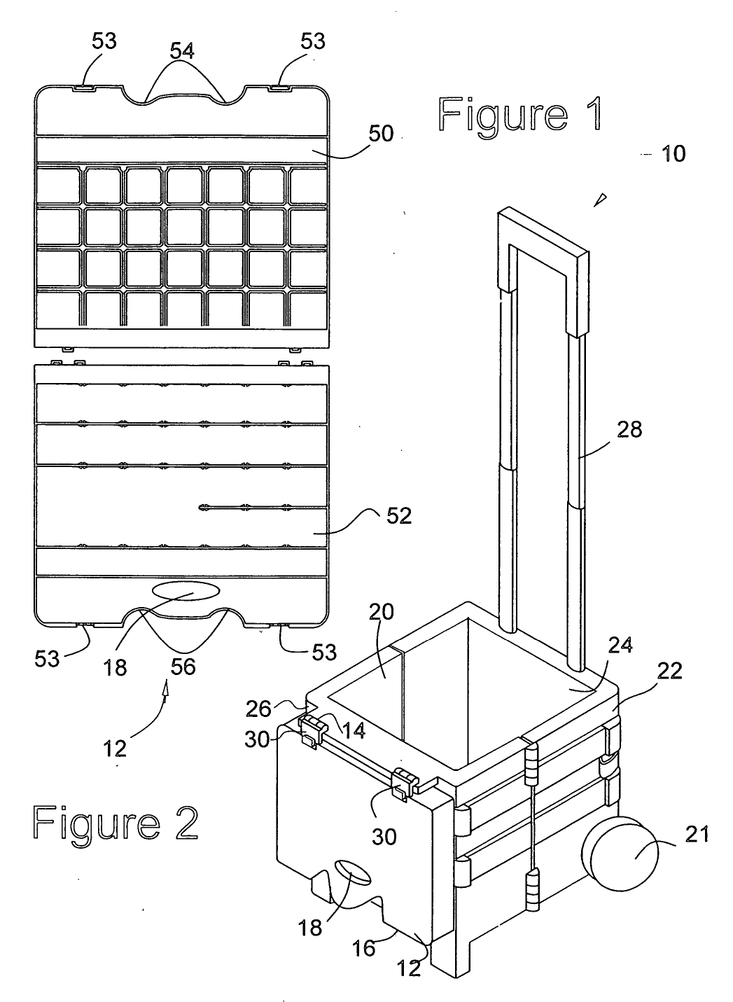

For the purposes here, the term “arc” refers to an arcuate region as seen, for example, in FIG. 1. Arc, arch and arcuate are interchangeable within this disclosure.

The disclosed caddy 10, as illustrated in FIG. 1, is illustrated in the open position. The caddy 10 has hinged sidewalls 20 and 22 that enable caddy 10 to fold, bringing front wall 26 toward rear wall 24. The rear wall 24 contains handles 28 that can retract into, or adjacent to, the back wall 24. The embodiment illustrated in FIG. 1 has rear wheels 21 to enable the caddy 10 to be easily rolled.

To enable the caddy 10 to more easily hold small items, the lid of the disclosed caddy 10 is a partitioned container 12, illustrated in FIG. 2, which can be manufactured with sufficient strength to enable the container to be used as a seat. The partitioned container 12, or other rotating lids disclosed hereinafter, can be hinged to lip 14 of front wall 26 using either standard hinges or separable hinges 30. As an alternative to container 12 being attached to front wall 26 of caddy 10, container 12 can be affixed to any non-collapsible portion of the caddy, although the embodiment employing lip 14 as disclosed in more detail hereinafter, can only be employed on front wall 26. In other embodiments, depending upon end use and manufactures preference, container 12 can be affixed with other securing mechanisms, such as snap clips, slide, loops, snap in locks, snap in fasteners, magnets or any rotating or non-rotating equivalency that enables the container or lid to be rotated and/or removed to permit access to the interior of caddy 10. Additionally, the access to the release, whether it is a clip or other type of mechanism, can be accessible when the container 12 is open or closed and will be dependent upon manufacturer's design.

In alternate embodiments container 12 can be redesigned to enable multiple other uses. This can include padding container 12 to carry delicate items such as a laptop or other electronic equipment. Alternatively, container 12 can be divided to carry a single large item, such as a retractable extension cord, with space for smaller items around. It should also be noted that the partitions and depth can be adjusted to hold such items as CDs and CD player. The container 12 can also be used as a lunch box or cooler, sizing some compartments to receive standard freezer packs. Alternatively, container 12 can be divided horizontally with the lid containing separate compartments that can contain freezer packs. The container 12 can also be one or more water holders to enable the user to carry water or other liquids. It should be noted that any of the embodiments disclosed herein can be combined with other embodiments and are not limited to the embodiments with which they are described.

The use of alternate securing mechanisms enables the container 12 to be attached to any wall or base portion of the caddy. In many embodiments, whatever the method of attaching container 12, container 12 is completely removable from the caddy. This removability enables container 12 to be stored in a location remote from the caddy for security reasons or convenience. Thus, container 12 can be moved to a table for sewing supplies, to a stream as a tackle box or locked in a safe place if used to hold or display jewelry.

In most applications the partitioned container 12 lies flush with front wall 26 when in the open position and adjacent the edges of front wall 26 and at least a portion of side walls 20 and 22 and/or back panel 24 when in the closed position. Therefore, when hinges, or other appropriate securing mechanisms, are used they should have sufficient rotation to enable partitioned container 12 to lie adjacent to the open end of caddy 10 in a first position and adjacent to front wall 26 in a second position. One method of obtaining the 2700 rotation required to enable container 12 to lie adjacent to both front wall 26 and the top is to provide a front rim, or lip 14, to caddy 10. By providing a rim 14, equal to the depth of container 12, container 12 is free to swing to a position that enables the non-hinged side to “store” under rim 14. In order for this attachment method to be successful, the container side of the hinge, or hinges can be positioned on the side of container 12 adjacent to the edges of the caddy 10 when closed while the opposing side of the hinge, or hinges, is connected to lip 14. Other methods of securing the container to the caddy while providing the required rotation will be evident to those skilled in the art.

The partitioned container 12 of FIG. 2 consists of a partitioned bottom 50 and a cover 52. The handle 18 in this embodiment is a cut out portion, however the handle can be of any configuration that will enable container 12 to open and close. In the embodiment illustrated herein, container 12 has an outer periphery about equal to that of the periphery of the open caddy. To enable container 12 to interact with handles 28, the opening end of both bottom 50 and cover 52 can have caddy handle recess portions 54 and 56 that are dimensioned and positioned to receive handles 28. Alternatively the container can be dimensioned to rest on the periphery of open caddy 10 with the container side proximate handles 28. In this configuration a carrying handle can extend from the container, resting on the caddy edge between the handles 28. Other dimensioning of the container will be evident to those skilled in the art. The cover 52 is hinged to bottom 50 using means known in the art that will enable cover 52 to open while container 12 is resting on the open end of caddy 12. Additionally, any latch system, such illustrated latch 53, can be such that it maintains container 12 closed during transportation.

In embodiments where the container 12 does not extend completely from front wall 26 to back wall 24, caddy handle recess portions 54 are not necessary. For example, in the embodiment illustrated in FIG. 13, container 200 does not extend to the back edge 202 of the caddy 206 and therefore does not interfere with the handles 204. It should be noted that the support for the container 200 is predominately on three sides as opposed to on all four sides as disclosed in other embodiments herein.

It should be noted that although the figures herein illustrate a single lid with opposing compartments, the partitioned container can be divided in any number of ways that will achieve the desired results. In addition to the standard flat lid and partitioned bottom, the container can be divided horizontally with closed, partitioned compartments on the lid and open compartments on the bottom. In designs where the lid is compartmentalized, the access can be from either the exterior or interior of the container. For example, the lid could have several small, hinged areas that permit access to one or more of the partitioned areas without opening the entire lid. The variations to the partitioned container will be evident to those skilled in the art.

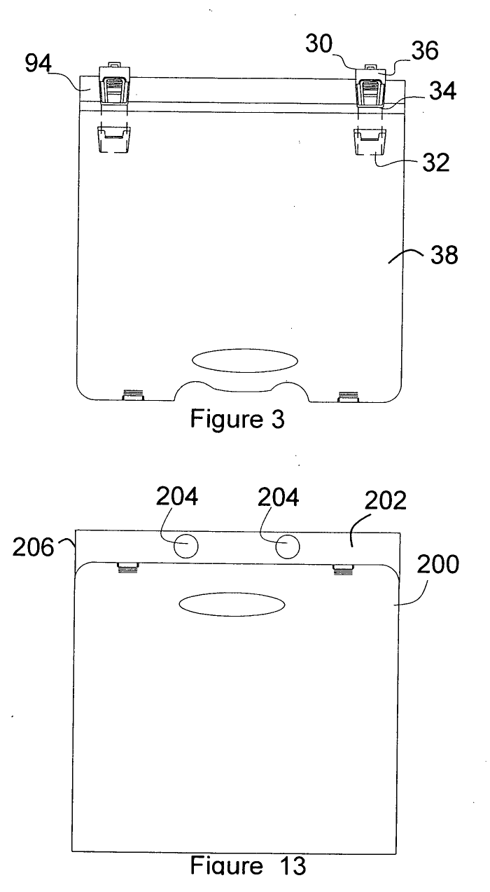

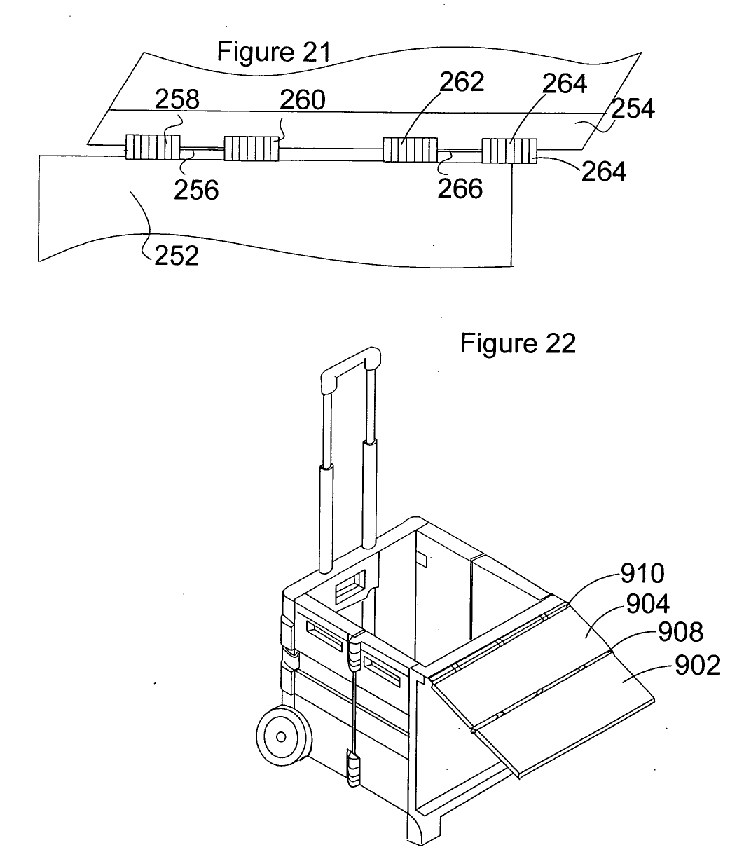

In the embodiment illustrated in FIG. 3, separable hinges 30 are manufactured in two parts to enable the partitioned container 38 to be removed from the caddy 70 of FIG. 5. The caddy portion 36 of separable hinges 30 is connected to the front rim 40 while the container portion 32 is recessed into the base of partitioned container 38. The separable hinges 30 illustrated herein are shown to be separated by a release button, however any equivalent release method can be incorporated, such as sides that press inward, twisting a release section, or slide pins as illustrated in FIGS. 20 and 21 and described hereinafter.

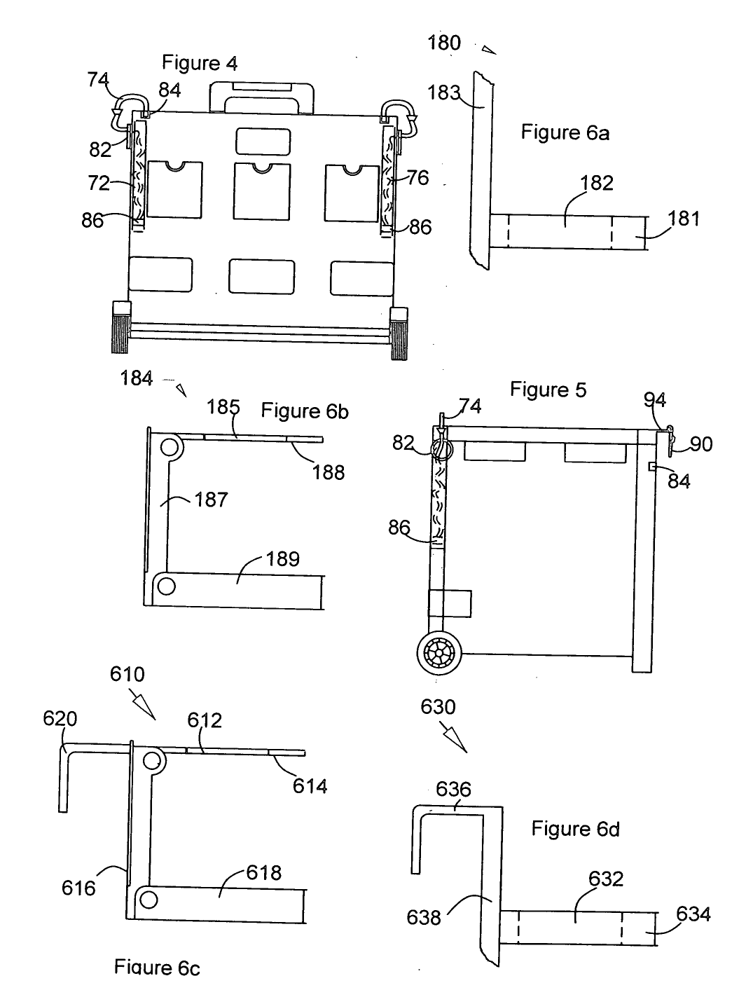

As the caddy 10 is advantageous for carrying items on top of the caddy 10, as well as within, securing, or bungee, or the equivalent elastic or non elastic, cords provide a means to maintain any articles being carried on top of the caddy 10. In the embodiment illustrated in FIGS. 4 and 5, the securing cords 76 are stored in a pair of cord recesses 72 at the back corners of the caddy 70. In this embodiment the securing cords 76 have hooks at one end that are maintained in a receiving hole 78 placed in the top edge of the caddy 70. Alternatively, hooks 74 or other equivalent retaining mechanisms can be provided to maintain the securing cord hooks 74 adjacent to the caddy 70. The end of securing cords 76 in this embodiment are provided with a stop disc 86 that has a diameter greater than the exit port 82. The securing cord 76 is pulled until the stop disc 86 comes in contact with the exit port 82, thereby providing resistance. This prevents the securing cord 76 from having to be removed from the recess 72 and secured at both ends. Although the securing cord can be affixed to the bottom of the recess, it requires additional cord and makes the storage more difficult.

In conjunction with any of the attachment methods taught herein, the front of the caddy 70 of FIG. 5 can provided with a loop or recess 84 to receive hook 74. Alternatively, the securing cord 76 can be brought completely around the articles being secured and hooked in the receiving hole 78. Alternate methods of securing the cords will be evident.

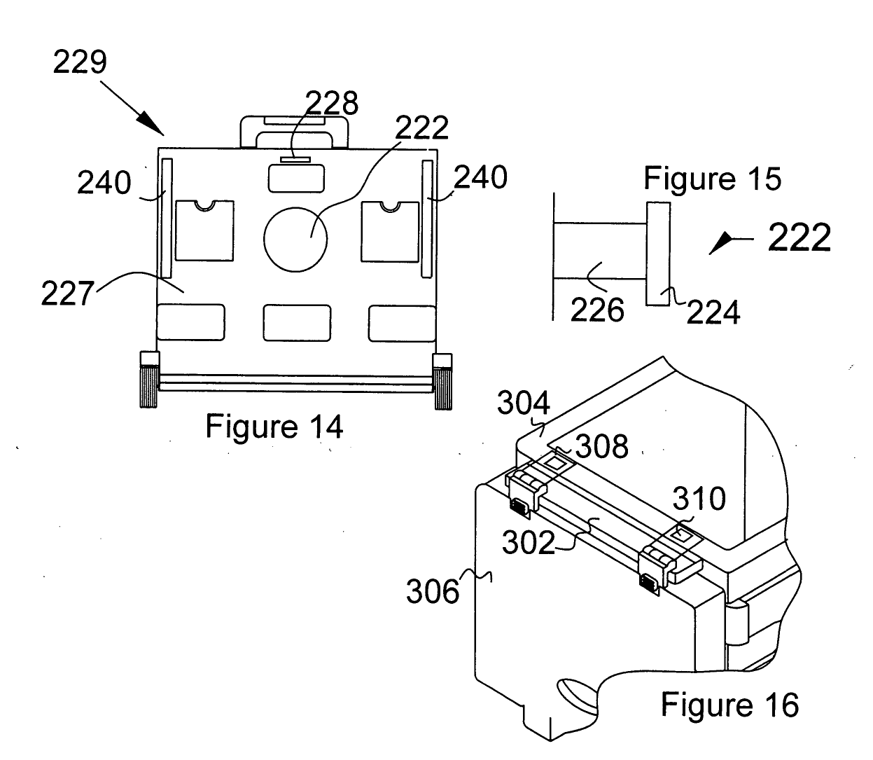

The securing cord 76 can also be placed inside one of the recessed small item holders 190 illustrated in FIG. 7 with one end secured to the caddy 80 within the holder 190. Alternatively securing cord 198 can be loose within the holder 190 and independently secured to the caddy upon use. As an alternative to having recessed securing cord holders, as illustrated in FIGS. 4 and 5, a securing cord can be wrapped around a holder 222 as shown in FIG. 15. The holder 222 as illustrated in FIGS. 14 and 15 is a bar 226 with a stop plate 224 to prevent the cord 76 from sliding of, although other designs providing the equivalent retaining areas can be incorporated. An eye hook or loop 228, or notch in the back panel of caddy 229, can be used to retain the end of a securing cord.

As seen in FIG. 5, when the container 38 is removed from the caddy 70, rim 94 and caddy portion 36 remain forming an L on the caddy 70. Alternatively the hinges 30 can be reversed, with the container portion 32 of hinge 30 recessed into the caddy. The container 38 can be permanently affixed to the caddy 70 however, as it is not a necessity to have container 38 removable, it is advantageous to the user.

The back side wall of the disclosed caddy 70 is an ideal location for smaller individualized recessed holders, although individualized holders can be recessed in, or placed on, the exterior or interior of any panel of the caddy. Examples of such holders are cup holder 180 of FIG. 6, cup holder 184 of FIG. 6a, hanging cup holder 610 of FIG. 6b, hanging cup holder 630 of FIG. 6c and/or a key, or other miscellaneous small item holder 190 of FIG. 7.

The cup holder 180 of FIG. 6a is a hinged, or otherwise extendable unit that can be recessed into caddy wall 183 to enable the holder 180 to be flush with the exterior of caddy wall 183 when in a closed position. A cut out 182, or other means known in the art, of retaining a cup is provided with cut out 182 being set into the holder body 181. Alternatively holder 180 can be attached directly to the exterior of caddy wall 183, protruding slightly.

In the embodiment illustrated in FIG. 6b, the cup is slid through receiving hole 185 that is within upper frame 188, with the bottom of the cup resting on the base panel 189. As illustrated upper frame 188 and base panel 189 are pivotable from back panel 187. This embodiment can be manufactured separately and then attached directly to a recessed area within the wall of the caddy, enabling it to lie flush with the exterior when closed. Alternatively, upper frame 188 and base panel 189 can be pivotably attached directly to the recessed backside wall of the caddy without the use of back panel 187. This is a manufacturing decision and will be evident to those skilled in the art. The cup holder 184 can also be attached directly to the face of the caddy wall, protruding slight.

In the embodiment hanging cup holder 610 illustrated in FIG. 6c, a cup is slid through receiving hole 612 that is within upper frame 614, with the bottom of the cup resting on base panel 618. As illustrated upper frame 614 and base panel 618 are pivotable from back panel 616. Hanger 620 is dimensioned to enable the hanging cup holder 610 to be placed on the edge of any of the caddies illustrated herein. The dimensioning of the hanger 620 should be such that it does not permit the hanger 620 to tip under the weight of a filled cup.

The hanging cup holder 630 illustrated in FIG. 6d has a cup receiving area 632 within a base 634. A hanger extension 638 is affixed to the base 634 at right angles at a distal end and to hanger 636 at the proximal end. The length of the hanger extension 638 can vary. The hanger 636 is, as noted heretofore, dimensioned to be received by the edge of an of the caddies illustrated herein and should not tip under the weight of a filled cup.

The small item holder 190, illustrated in FIG. 7, can be provided with a pair of side closures 192, extending between caddy wall 196 and item holder front panel 194 to retain small articles. The side closures 192 and front panel 194 can be rigid, sliding within caddy wall 196, or flexible, compressing into the recessed space within the caddy wall 196. The size of article capable of being retained within the closed small item holder 190 will depend upon the depth and size of the holder. Both the cup holders 180 and 184 and the small item holders 190 can also be recessed within, or placed on, the back, sides or front of any of the caddies disclosed here.

It should be noted that the commonly used mold for the plastic, collapsible caddies has recessed portions as part of the design. The storage areas as described heretofore can be recessed within these recessed portions to enable the closed storage area to be flush with the outermost surface of the caddie wall. Alternatively, if the design of the caddy is such that there are no recessed portions, the mold can be redesigned to enable the storage area to be recessed or, alternatively, the storage area can be mounted onto the surface, thereby protruding from the wall face.

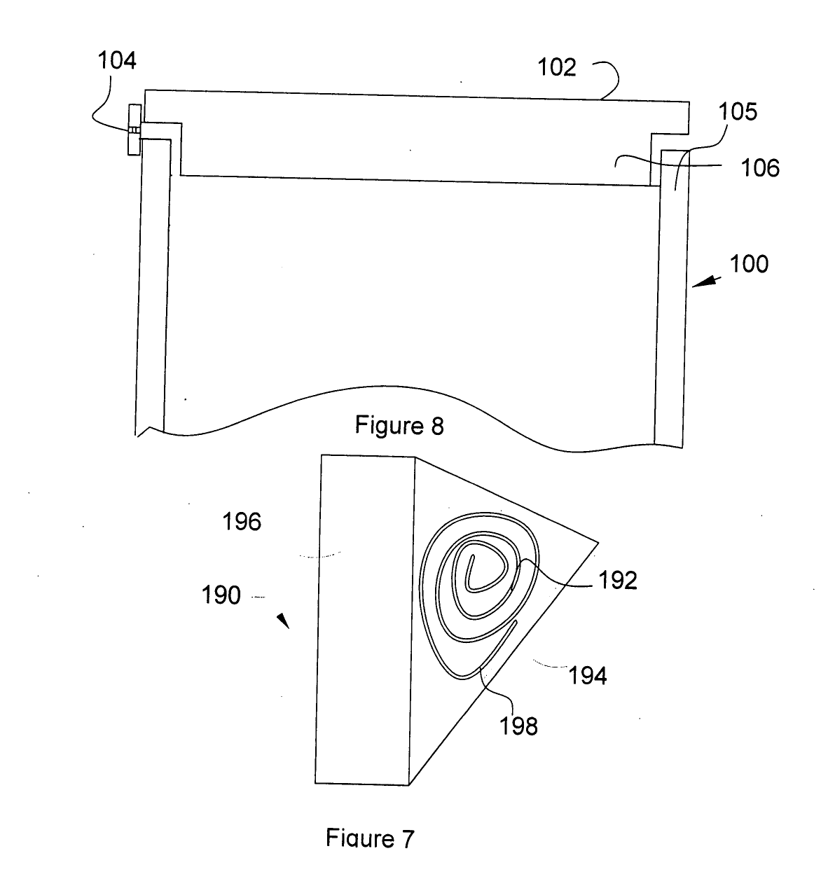

In the embodiment disclosed in FIG. 8, partitioned container 102 is recessed into the open top of caddy 100. This enables the depth 130 of partitioned container 102 to be greater than that of the foregoing embodiments without adding any additional height to caddy 100. In order to swing open, the extended portion 106 can be recessed a sufficient amount from caddy walls 105 to prevent the extended portion 106 from coming in contact with walls 105 while opening. Any horizontal dividing of the partitioned container 102 should take into account the need for the container 102 to be removed from the caddy 100 or swing open, using the hinges 104, as a single unit. Any additional latches or hinges will be evident to those skilled in the art.

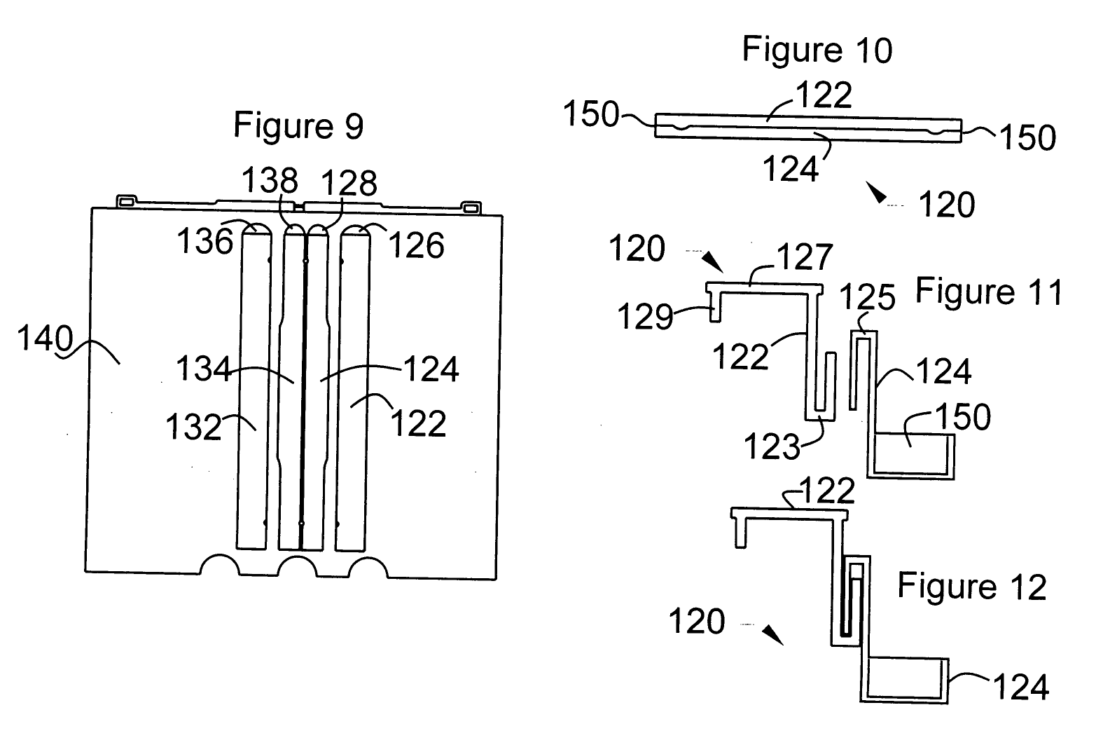

The interior of the caddy 10 can also be used to hang files. In order to prevent the file holders from interfering with other uses for the caddy 10, hanger pairs 120 and 130, illustrated in FIGS. 10-12, or other file holders disclosed herein, are stored in the base 140 of the caddy 10 as illustrated in FIG. 9. The hanger pair 120 and 13O consist of a caddy portion 122 and 132 and a file portion 124 and 134. Although the file hangers can be manufacture as a single unit, as disclosed hereinafter, in some applications the dual units can be advantageous. Modifications to the base 140 of the caddy to accommodate other hanger designs or items will be evident. As can be seen from FIGS. 11 and 12, the caddy portion 122 and the file portion 124 of the holder set 120 lock together to form the completed holder set 120 of FIG. 10. The locking method illustrated herein is through the interaction of the U-shaped member 123 on the caddy portion 122 and reverse U-shaped member 125 on the file portion 124. The top plate 127 of the caddy portion 122 is placed over the rim of the caddy 10 with the back support 129 on the outside of the caddy 10. The exterior support 129 should have sufficient length to provide the support required to maintain the top plate 127 adjacent to the rim of the caddy 10. The reverse U-shaped member 125 and the U-shaped member 123 are dimensioned to interlock with one another to provide the support required to securely hang files. Too close a fit between the two members will make the system difficult to use while too loose a fit will cause the two members to separate unintentionally. This is one example of a method to interlock the holder set 120 and other methods and designs will be evident to those skilled in the art. To provide security and stability, the caddy portion 122 and the file portion 124 can interlock along a substantial portion of their length. The material of manufacture can be a metal, plastic or other material able to the weight of the files and that will not otherwise deform. The ends 150 of the file portion 124 are closed in order to prevent the hanging file folders from sliding off the ends, however in some embodiments the ends can be left open. Alternatively, the ends 150 can be removable from the file portion 124, affixing to the file portion 124 through friction fit, tab and groove or other mechanisms known in the art.

Since the hanger pairs 120 and 130 can be recessed into the caddy base 140, to prevent obstruction of the caddy base 140 during other uses, finger holes 128, 126, 136 and 138 are provided. Theses recessed areas enable the user to contact the end of the hanger pairs 120 and 130 and remove them from the base 140. Alternatively, the finger holes 128, 126, 136 and 138 can be placed along the length of the hanger pairs 120 and 130 to enable removal. The depth of the recesses should be sufficient to enable the hanger pairs 120 and 130 to recess fully into the base 140 and can be maintained within the base through flanges, friction fit, or other means known in the art.

In order to protect the back of the caddies disclosed herein, runners 240 can be added to back panel 227, as illustrated on caddy 229 in FIG. 14. The runners 240 can be raised beyond the level of back panel 227, as well as any of the holders, thereby preventing contact of back panel 227 while going up stairs, lifting onto platforms, etc. The number of runners 240 and their placement will be dependent upon end use and size of the caddy 229 and will be evident to those skilled in the art. The runners 240 can be manufactured from any material that will provide the resilience and protection required while not creating friction with the adjacent external surface.

An alternate method of making the container removable is illustrated in FIG. 16 wherein lip 302 is removably attached to caddy 304. The container 306 is hingeably connected to lip 302 and can be connected in either a removable or permanent manner. In this embodiment the connectors 308 are recessed within lip 302 and front of caddy 304 and released from caddy 304 through the use of buttons 310 or other release mechanisms, such as slides, turn buckles, or their equivalents. It should be noted that this is one manner of removably securing the two units together and other methods will be evident to those skilled in the art.

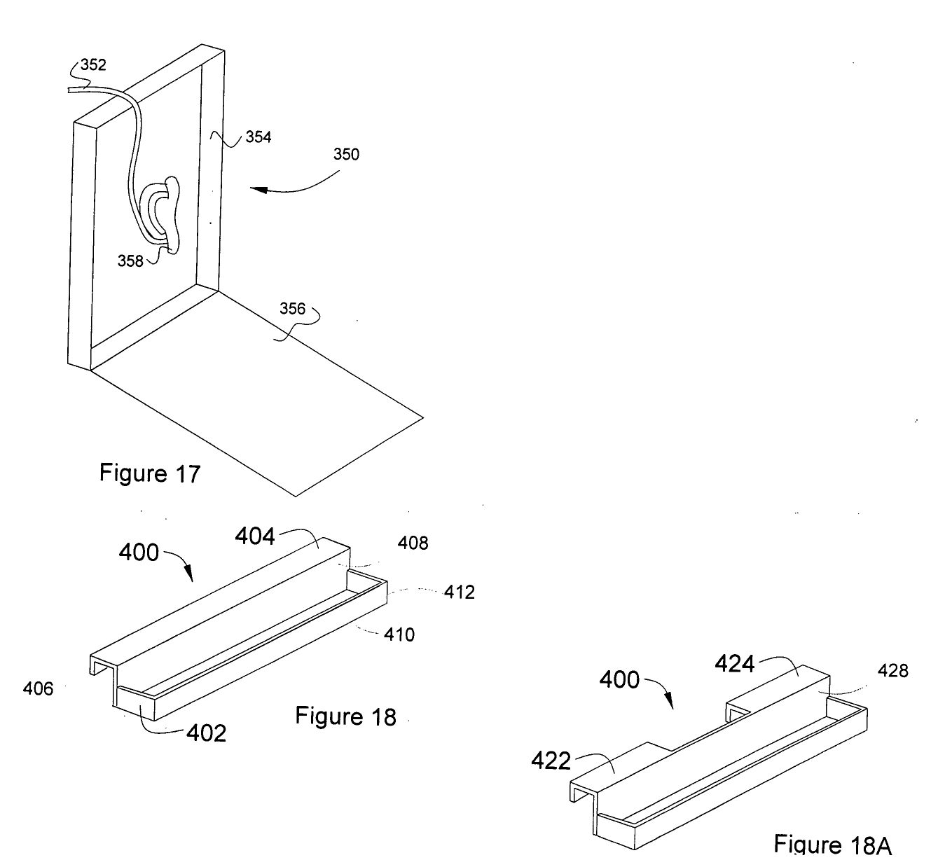

In FIG. 17 the securing cord storage area 350 consists of a holder 354 and a cleat 358. The holder 354 can be either recessed into, or extend outward from, the caddy panel. In the illustrated embodiment storage area 350 has a door 356 that closes and to hide cleat 358 and securing cord 352. The door 356, which can be secured in any manner known in the art, provides protection for cleat 358 and securing cord 352, as well as has aesthetic value. In alternate embodiments, especially where storage area 350 is recessed into the caddy, the door can be eliminated. In this embodiment, securing cord 352 is maintained wrapped around cleat 358 until needed. During use only the amount of cord 352 required to secure the object(s) to the caddy is unwound with the remaining cord 352 being left wrapped around cleat 354. Other designs for the cleat, or cord holder, will be evident to those skilled in the art and will be determined to some extent by the decision as to whether or not to recess the cord and/or include a cover. The securing cord holder can also be of any other design known for use with buggies, cords or other cord type devices. This includes retractable seatbelt type devices as well as mechanical mechanisms such as a crank or wind around bar that is, for example, pulled out to wind and pushed in to lock. The various method of storing the securing cords will be evident to those skilled in the art.

In FIGS. 18 and 18A alternate J-shaped hanging file folder holders 400 and 420 are disclosed that are a single molded piece that is secured to the caddy by placing the top plate 404 or 422 and 424 over the top edge of the caddy. To maintain the holder 400 in place a back plate 406 extends from the top plate 404 at right angles and is placed on the exterior of the caddy. As illustrated in FIG. 18A the back plates 422 and 424 can be two pieces, having a space between them, that extends along a substantial portion of the length of holder 420 to leave space between the two back plates 422 and 426 the caddy hinges. Alternatively, the back plate can be multiple pieces that only extend along a portion of the length or curved as illustrated in FIGS. 33 and 34 hereinafter. However accomplished, the design of the body 404 and back plate 406 can be such that it accommodates the hinges of the caddy.

Opposing back plate 406 is front plate 408, also extending at right angles to top plate 404. The depth of front plate 408 can be sufficient to enable hanging file folders to rest on receiving rim 412 and still enable the caddy lid to close. The receiving rim 412 is connected to front plate 408 by connecting plate 410. In hanger 400 the ends of connecting plate 410 and receiving rim 412 have been closed using end plates 402, thereby preventing the hanging file folders (not shown) from sliding off the ends of the hanger 400. As described heretofore, end plates 402 can be permanently affixed to connecting plate 410 and receiving rim 412 or be designed with mechanisms that enable removability. In this embodiment, as well as other disclosed hanger embodiments, to enable hanger 400 to easily fit over the side of the caddy, approximately ½ to ¾ inch can be left between the caddy edge and each end plate 402 of the hanger.

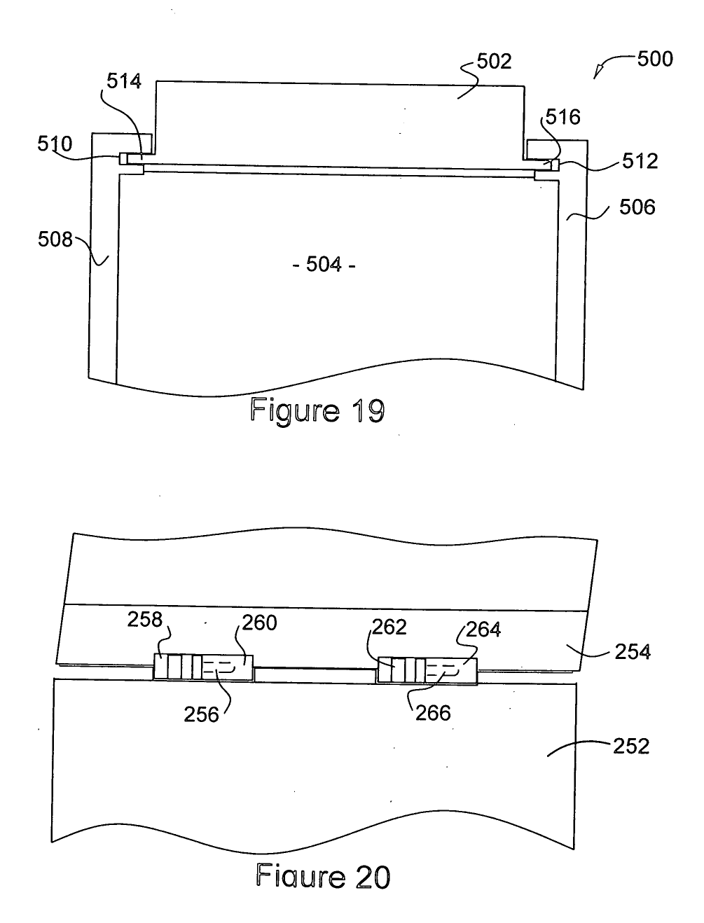

An example of a slide arrangement is illustrated in the alternate embodiment of caddy 500 of FIG. 19. In this embodiment the back panel 506 and front panel 508 are each provided with a receiving channel 512 and 510 respectively. The container 502 is, in turn, manufactured with flanges 514 and 516 that interact with receiving channels 512 and 510. In order to enable container 502 to slide into channels 512 and 510, back panel 506 and front panel 508 can be raised a sufficient distance to enable container 502 to clear hinged side panels 504. The container 502 is then free to slide in and out of channels 510 and 512. Because of the folding features of sides 504, receiving channels 510 and 512 are most effective when placed on back panel 508 and front panel 506.

In the embodiment of FIGS. 20 and 21, container 252 is connected to caddy lip 254 through two hinge pairs consisting of first hinge portions 2588 and 260 and second hinge portions 262 and 264. It should be noted that although two hinge pairs are illustrated herein, as many or as few as required to provide the appropriate attachment can be used. In the illustrated embodiment of FIG. 20, container 252 is mounted on caddy lip 254 in a ready to use position. To remove container 252 from caddy lip 254, container 252 is slid to the left thereby removing rotating pins 256 and 266 from second hinge portion 260 and 264 respectively. Once pins 256 and 266 are removed, container 252 is free to be carried. To remount container 252, the pins 256 and 266 are aligned with, and slid into, second hinge portions 260 and 264. As will be obvious to those skilled in the art, the direction of movement or portion of hinge that retains the rotating pin is irrelevant and additional designs and configurations will be evident.

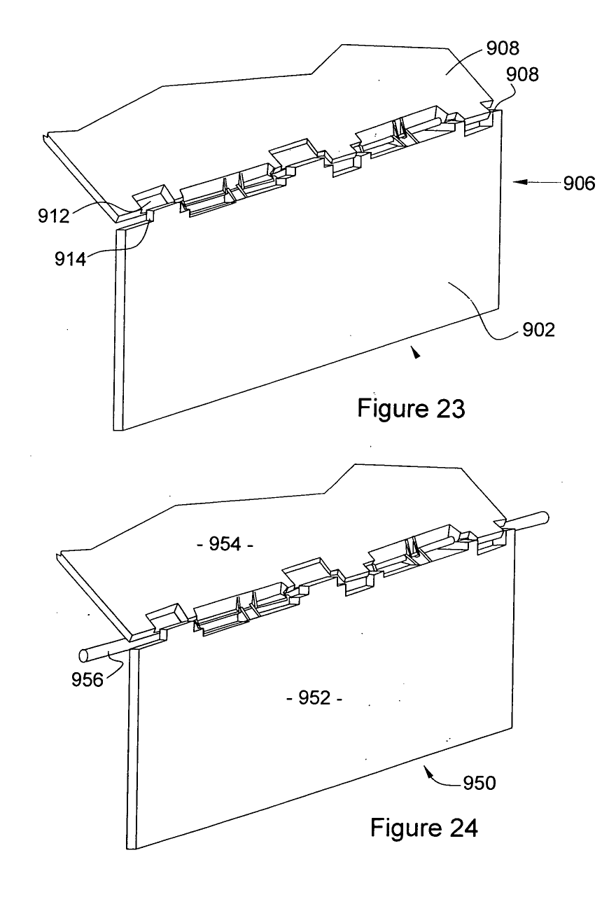

In FIGS. 22 and 23 the caddy has a center hinged top 906 that consists of forward section 902 and rear section 904 joined by hinge 908. In this embodiment, forward section 902 can be opened back onto rear section 904 enabling the user to only open half of top 906. The hinge 908 as illustrated provides for an interlocking security through the interaction of peaks 914 and opposing valleys 912. This, or any other applicable interlocking method, prevents hinge 908 from collapsing inwardly and can provide sufficient strength to enable center hinged top 906 to serve as a seat. The center hinged top 906 is hinged to caddy body at hinge 910 in accordance with any of the disclosed methods. It should be noted that although center hinged top 906 is illustrated as a single layer top, the container as disclosed heretofore, can also be hinged in the same manner.

In FIG. 24 an alternate hinge top 950 is disclosed that includes a center bar 956 as part of the hinge system. In this embodiment, center bar 956 extends beyond forward section 954 and rear section 952 to interact with receiving notches placed in the caddy. This enables hinge top 950 to be snapped in and out and permits both forward section 954 and rear section 952 to be opened separately. It should be noted that the illustrated hinges are examples and any type of hinge that will meet the criteria set forth can be used.

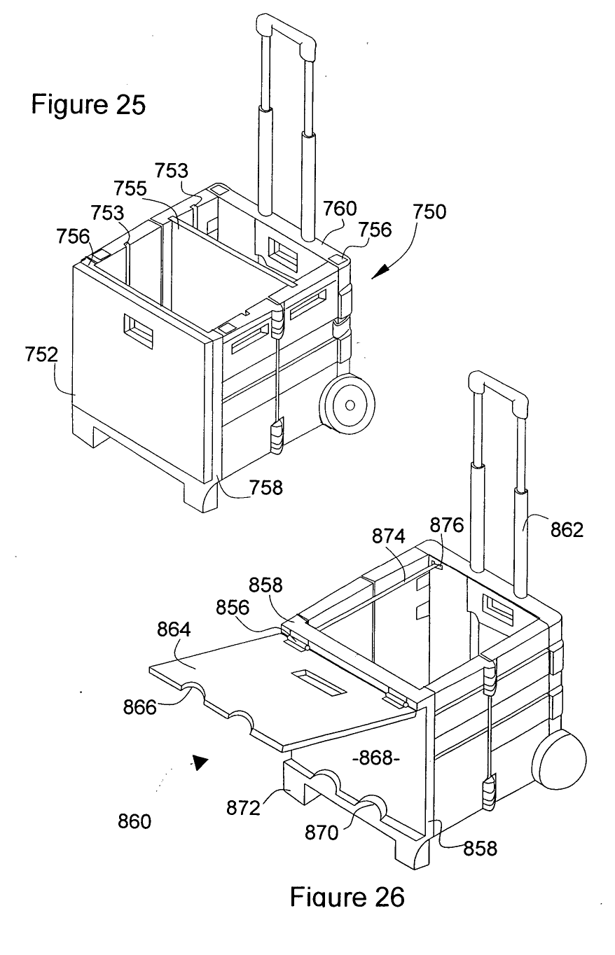

The caddy 750, as illustrated in FIG. 25, has incorporated a flat top panel, or lid, 752 rather than the partitioned container 20. The lid 752, as can any lid design disclosed herein, can be secured to caddy edge 760, as well as front panel 758 and/or back panel 760 through use of securing means 756, for example magnets, snap locks, Velcro®, or other methods. Use of securing means 756 makes lid 752 easily, and quickly, removable from caddy 750. It should be noted that since lid 752 does not provide cut outs to receive the handles, as disclosed further herein, the length of lid 752 is such that it does not come in contact with the handles when closed. The lid 752 can extend the full length of the caddy 750 as disclosed herein. FIG. 25 also illustrates the divider channels 753 and divider 755. The divider channels 753 enable a single divider to be moved or multiple dividers to be incorporated within this or any of the caddys disclosed herein.

In the caddy 860 embodiment of FIG. 26 the lid 864 is provided with cutouts 866 that are dimensioned to fit around the handle base 862. In this embodiment, front panel 858 has a recessed lid receiving area 868 that is also similarly provided with arcs 870 that are dimensioned to receive cutouts 866. In this way, when lid 864 is open, lying adjacent receiving area 868, front surface is flush with base 872. As noted heretofore, in order for lid 864 to rotate the required 270 degrees, a lip 858 extends from lid receiving area 868 a distance equal to the thickness of the lid 864. The hinge 856 can be multiple, smaller hinges, permanent or removable, or one long hinge extending across the entire width of the caddy 8600. This is dependent upon the weight to the lid, type of hinge, end use, manufacturing costs, etc., and can be decided at time of manufacture. Additionally, in the event support braces, or other accessories, described hereinafter, are to be incorporated for the end use of a particular caddy design, the hinge may require raising from the top edge of the caddy. This can be accomplished by raising the front edge an amount equivalent to the thickness of the add-on accessories.

This figure also illustrates one method of retaining hanging items, such as file folders. Receiving rod brackets 876 are placed proximate each corner, spaced a sufficient distance from the sides to provide clearance for the hanging folders. File rods 874 are subsequently inserted into rod brackets 876 and the folders placed onto rods 874. The rod brackets can be added after manufacture or molded into the caddy. Alternatively, a hole can be drilled into one side of the caddy and a notch into the other side receive the file rod.

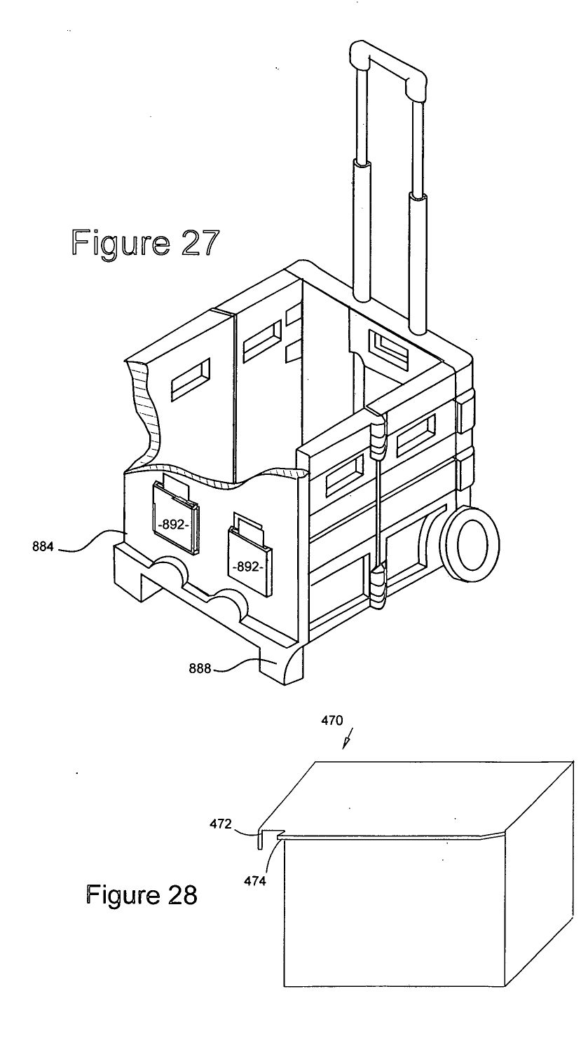

Alternatively, as illustrated in FIG. 27, the lid (not shown) can be spaced from the recess area 884 as disclosed heretofore, bringing the width of the lip an amount sufficient to bring the lid in contact with the front panel 888 rather than in contact with the recess area 884. By spacing the lid from the recessed area 884, pockets 892 or other items, can be placed within the recessed area 884. The pockets 892 can be used to hold flyers, sales materials, etc.

Alternative to placing the pockets or holders directly onto the caddy, the pockets can be affixed to a snap-in panel that is placed within the recess 884. The panel can be held in through the use of receiving notches placed in the top of the panel to interact with tabs in the top of the recessed area of the front panel. Other methods of removably securing the panel into either the recessed area or onto the front panel of the caddy can be used and will be evident. One quick method of applying the panels is with magnets placed along the back of the panel. Magnetic strips, or individual magnets, can be placed in corresponding locations on the caddy to receive the panel. It should be noted that the removable panels, in any securing method, can be placed along the front, back or sides of the caddy.

In FIG. 28, a box insert 470 is provided with the L-shaped lip 472 to secure the box insert 470 to one side of a caddy. In some positions within the caddy, the support lip 474 would contact the front panel, and therefore the hinge, of the caddy. To avoid interfering with the hinge, the support lip 474 is a flat element rather than a L-shaped clip-on. The dimensioning of the lip 472 can be such that it does not interfere with the handles when placed on the back corners. The interior of the box insert can also contain dividers to section the interior. The box insert 470 can extend either the complete depth and/or width or only a portion of the depth and/or width of the caddy.

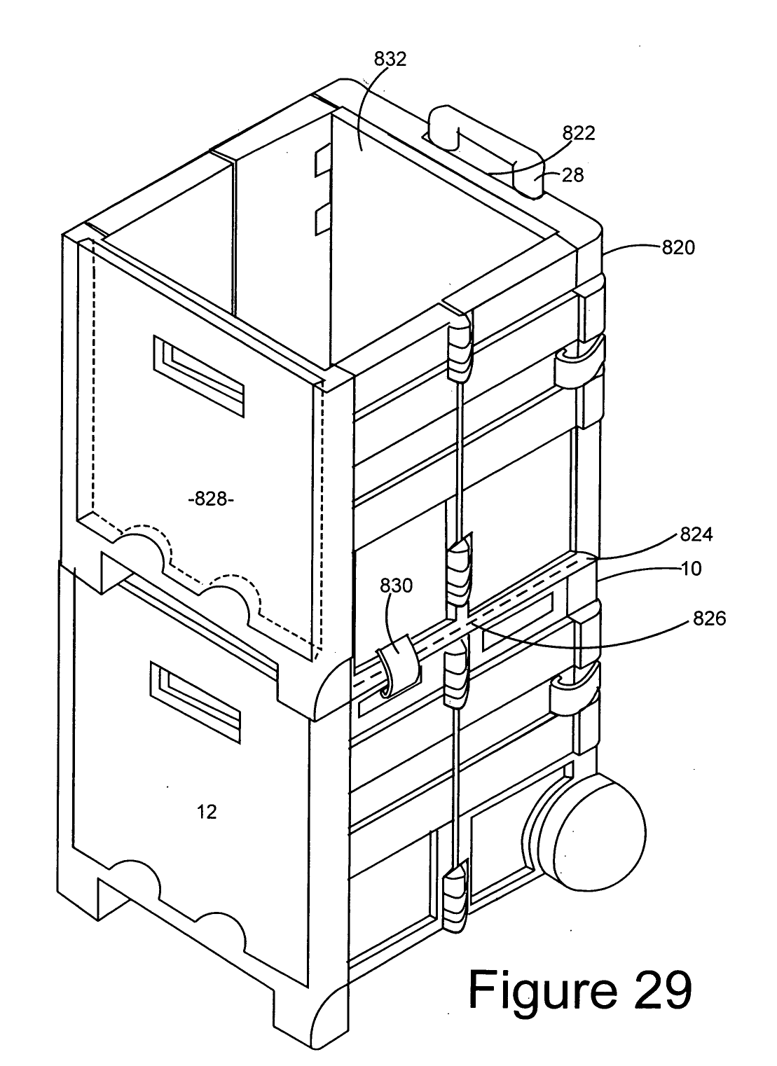

In FIG. 29 a top caddy 820 is illustrated that has been designed to interact with the foregoing wheeled caddies. Although in this figure reference is made to wheeled caddy 10, top caddy 820 can be used with any of the wheeled caddies disclosed herein. The top caddy 820 has a flat base 824 and, in this embodiment, a recessed channel 826 that interacts with the top of wheeled caddy 10 to help prevent slipping. The recessed channel 826 is an optional feature and the top caddy can be secured to the bottom wheeled caddy by other means. The top caddy 820 is provided with a cutout 822 that compensates for the handles 28 being recessed enables top caddy 820 to match edges with the bottom wheeled caddy. It should be noted that in this illustration bottom panel 832 of top caddy 820 is left adjacent the back panel while lid 12 is left open on the bottom wheeled caddy 10. This placement of lid 12 and bottom panel 832 provides a double depth to the unit, enabling the storage of larger, bulkier items. However, the bottom of the top caddy 832 can be left closed to divide the unit into two separate storage areas. This figure also illustrates the locking together of top caddy 832 and bottom wheeled caddy 10 through use of the snap clip 830. The clips 100 can be either loose clips that fit into notches placed into the forward or rearward side panels or, alternatively, the clips can be integral to one of the caddies and snapped onto the other caddy. If the clip is integral with one of the caddies, it is preferably the top caddy since the clip would only be used when securing one daddy to another.

As can be seen from this figure, the handles 28 extend a sufficient distance beyond top caddy 820 to enable the user to easily maneuver the combined units. More than one top caddy 820 can be placed on the wheeled caddy 10, with each top caddy 820 being attached to the lower caddy through use of snap clips 830. The handles 28 would be extended to a length sufficient to clear top stacking caddy 820 to enable the user's hand to comfortably grip handle 28.

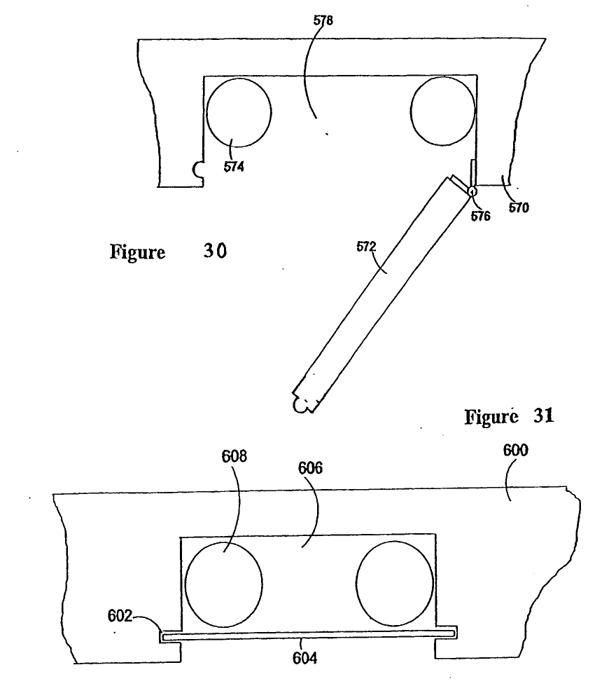

One method of maintaining the top caddy adjacent handles 574 of the bottom caddy and to accommodate handles having top grips, is illustrated in FIG. 30 wherein top caddy 570 has a molded receiving space 578 dimensioned to receive handles 574. A door 572, hinged to caddy 570 through the use of any applicable hinge 576, opens to receive handles 574 and then snap locks into the closed position. The method of maintaining the door closed can vary and will be known in the art. In FIG. 31 receiving area 606 is further provided with notches 602 extending at least most of the height of caddy 600. A panel 604 is dimensioned to slide into notches 602 once handles 608 are within receiving area 606.

When the caddy is used for outdoor activities, the wheels can be enlarged to make rolling over rough ground easier and rubber wheels can be used to further enhance movement over rough ground. The wheeled caddy is advantageous for camping enabling a user to easily transport miscellaneous items from the car to the campsite. When used in outdoor situations, covers are placed over the caddy to protect the contents.

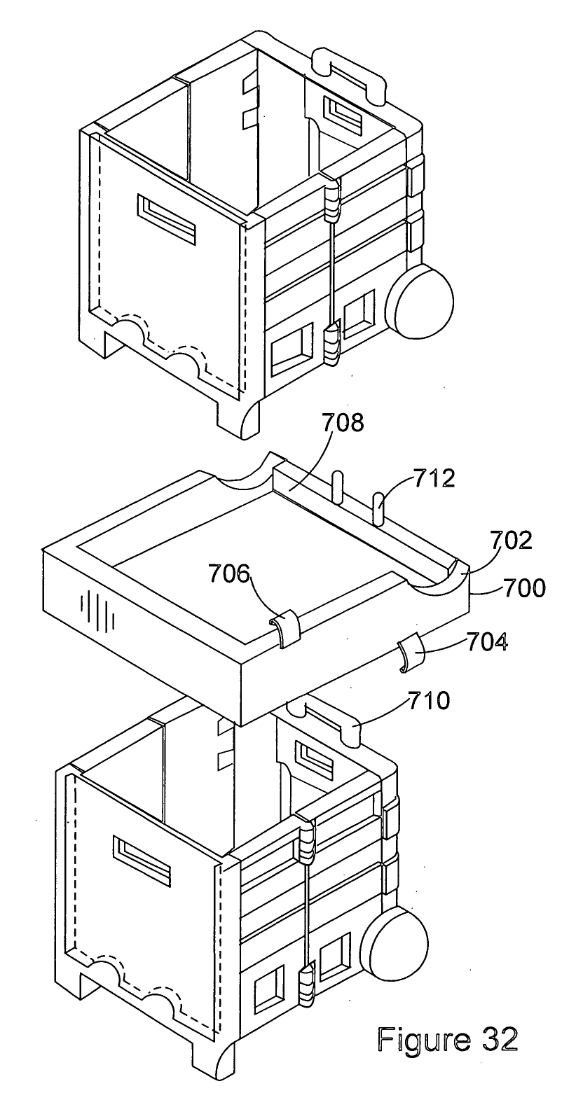

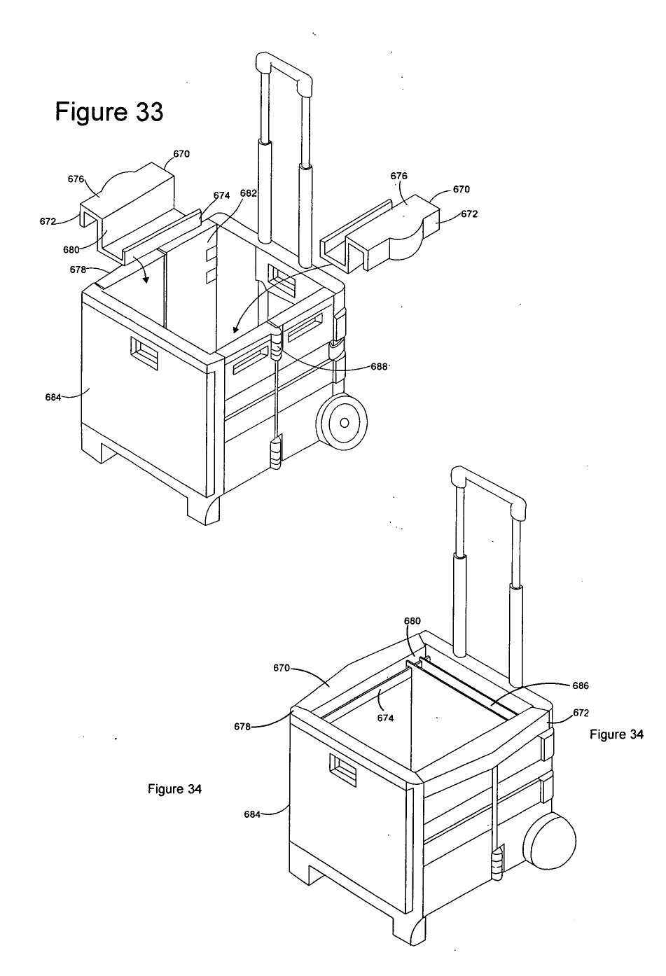

In FIG. 32, a caddy separator 700 is illustrated to enable two wheeled caddies to be stacked. The separator 700 has wheel wells 702 that are dimensioned to receive the wheels of the top caddy. The separator 700 is locked onto the two caddies through use of snap clips 704 and 706. The snap clips 704 and 706 prevent lateral movement between the two caddies, as well as preventing separation. The handle storage area 708 can be dimensioned to receive the handle 710 of the bottom caddy. Once locked, the handle of the top caddy can be used to roll the combined unit. Aligning tabs 712 can also be provided to interlock with the top caddy and provide additional support.

In FIGS. 33 and 34 a pair of hangers 670 are placed over side panels 678 to support items, such as hanging file folders. The back support 672 of the hanger 670 can be configured to accommodate hinges 668 to enable top plate 676 to lie adjacent the caddy edge 678. The brackets 674 are dimensioned to receive the hooks of hanging file folders or other hanging items, although other bracket configurations can be used to support specialized items. As illustrated in FIG. 34, the back panel 680 of the hanger 670 can have adequate length to drop brackets 674 a distance from the caddy edge 678 sufficient to enable removable lid 684 to close without being blocked by the hanging folders 686. As stated heretofore in conjunction with FIG. 18, the hangers can have either permanent or removable end closures to prevent the file folders from sliding off, however, other means can be used to prevent the folder hooks from sliding off. In embodiments wherein removable lid 684 is used, securing mechanism 685, such as magnets, should compensate for the thickness of the hanger 670 to ensure contact between the securing mechanism 685 on the caddy edge 678 and that on the lid 684. Alternative the securing means can be affixed directly to the hanger 670.

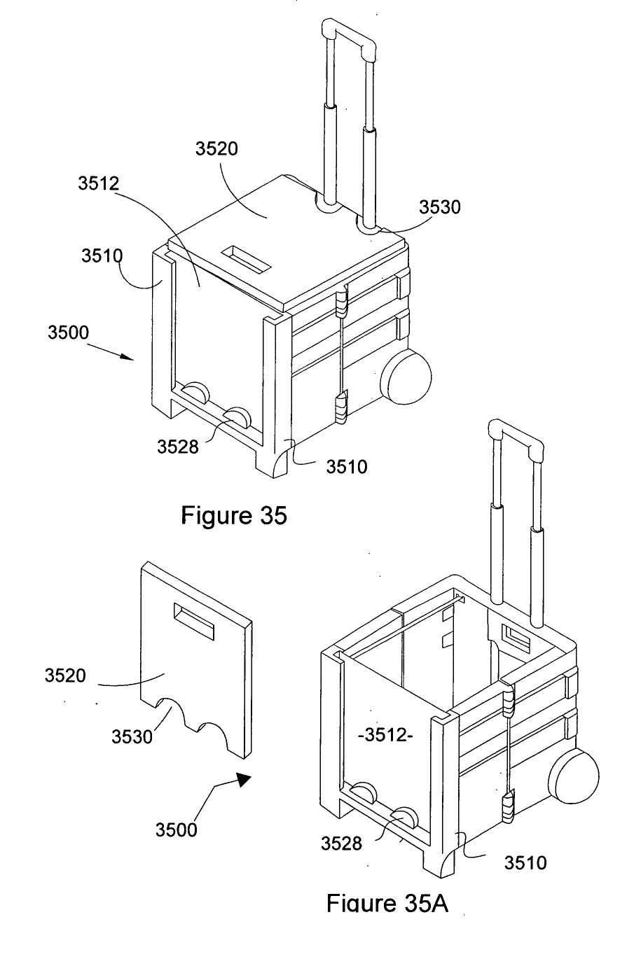

In FIGS. 35 and 35A the caddy 3500 has a pair of channels 3510 vertically on the front panel 3512 that are dimensioned to receive the lid 3520. The lid 3520 is maintained on the caddy 3500 by any of the securing methods disclosed here in and, when removed, is slid into channels 3510 for storage. The caddy 3500 has curved inserts 3528 to receive handle cutouts 3530, however this is optional and can be eliminated. This design enables the lid 3520 to be completely removed from the caddy 3500.

In FIG. 36 an alternative method of affixing a lid to a caddy is disclosed. The caddy 3610 is provided with a hinged guide bar 3616 that is affixed to the caddy 3610 by one or more hinges 3620. The lid 3630 is a modified C-shape dimensioned to slideably receive the guide bar 3616. The top and bottom of the lid 3630 are closed to prevent the lid 3630 from sliding off the bar 3616, as well as for aesthetic purposes. The lid 3630 is opened by lifting the lid 3630 parallel to the caddy 3610 and sliding the lid downward along the bar 3616 to lie adjacent the front of the caddy 3610.

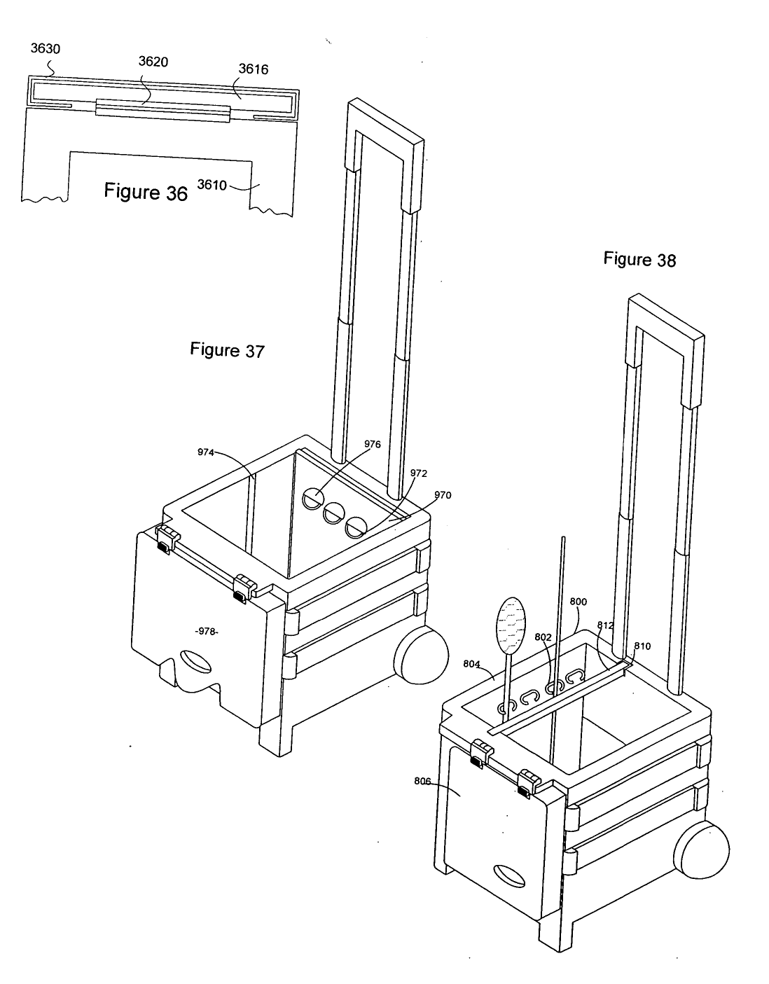

In FIG. 37 panel 970 slides into channels 974 provided within caddy and described in more detail heretofore. The clips 972 are, as described heretofore, used to retain items adjacent the back panel, and can be combined with pockets as previously noted. In this embodiment, clips 972 are provided with recess pockets 976 to maintain clips 972 flush with the surface of panel 970 when not in use. The clips 972 can be provided with springs that, when not being held in the downward position by items, return to recess pocket 976. The lid 978 can, optionally, be cut to accommodate the items placed within clips 972 and a support bar, as described heretofore, can be incorporated to provide added support. Although the fishing equipment is illustrated herein, it should be noted that the clips, pockets, etc. can be designed to hold tools, screws, electrical equipment, etc. Other type of clips or retaining methods can also be used to secure items, either removably or permanently, to the slidable panels.

Another use for the wheeled caddy is for sports and camping. In FIG. 38, a panel 800 is provided with snap-in clips 802 to receive items such as fishing rods and nets. The clips 802 can be paired, one located proximate the rim of the caddy, as seen, and the other proximate the bottom of the caddy (not shown). The illustrated panel 800 is affixed to the caddy through use of a L-shaped lip 804, such as used in conjunction with the hanging folders, described heretofore in FIG. 34. The L-shaped lip 804 has the same design as the top plate 856 of the hanger 850 with the back panel 860 replaced with panel 800. Other means, such as Velcro®, can be used to secure the panels to the caddy and will be obvious to those skilled in the art. Additionally, other clip designs, loops or other holding members for attaching a variety of items to the panels can be use. The lid 806 is, at the time of manufacture, proportioned to provide clearance for the items being held by the panel 800. In some embodiments, lid 806 would either be cut away on both sides to enable an additional panel 800 to be placed on the opposing side of the caddy, enabling both panels to carry tall. The panels can also contain pockets, snaps, Velcro® or other storage and/or attachment members, either alone or in combination with clips 802. A snap-in front panel as disclosed heretofore can be modified to hold the appropriate items, such as lures and bait. The modification of the snap-in panels and panels 800 also enable the same basic caddy to be used for various activities. Additionally, a cooler can be placed in the caddy to store items that need to remain cool.

When the lid is cut back to accommodate tall items, the strength of the lid is compromised and is not as safely used as a seat. Therefore, a removable support rod 812 can be incorporated to provide support to lid 806 when closed. Notches 810 can be provided in the sides to receive support rod 812, thereby keeping the lid flush with the back and hinge arrangement. For ease of illustration, support rod 812 of FIG. 38 is positioned on the side opposite the cutaway portion of the lid 806. In actual use, rod 812 would be placed at the cut edge to give the support usually provided by the caddy edge.

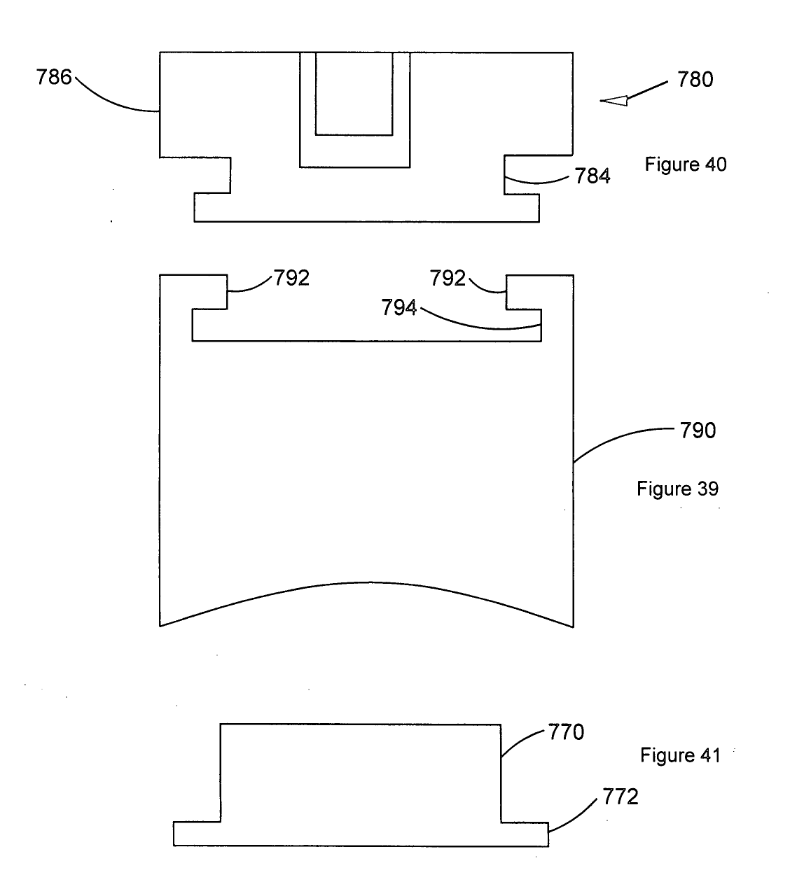

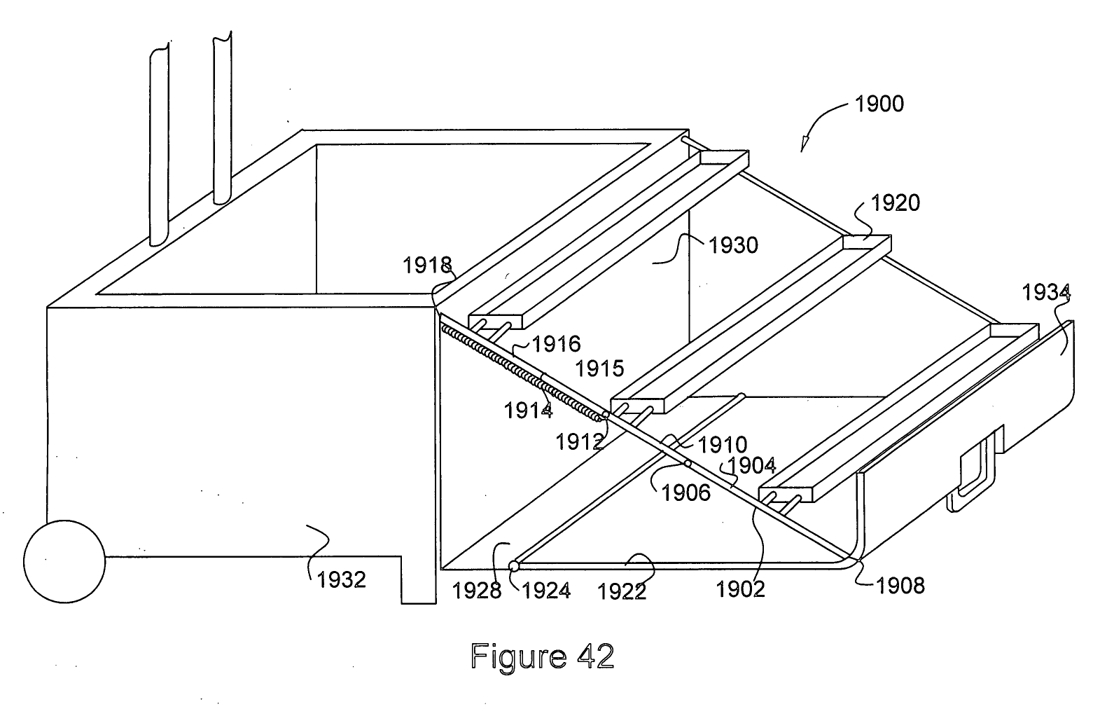

In FIG. 39 caddy 790 is provided with a slide channel 794 formed by L-shaped lips 792. The slide channel 794 is dimensioned to receive flanges 772 as illustrated on box 770 of FIG. 41. Alternatively, as illustrated in box 780 of FIG. 40, flange 772 can be replaced with channels 784 to interact with L-shaped lips 792. Although a box is illustrated in these figures, the slide channel/flange combination can be incorporated with any add-on. The channels 784 can be molded into one or more of the four sides of the caddy, dependent upon final use. Further, either of boxes 770 or 780 can be dimensioned to interact with the interior channels as described heretofore.

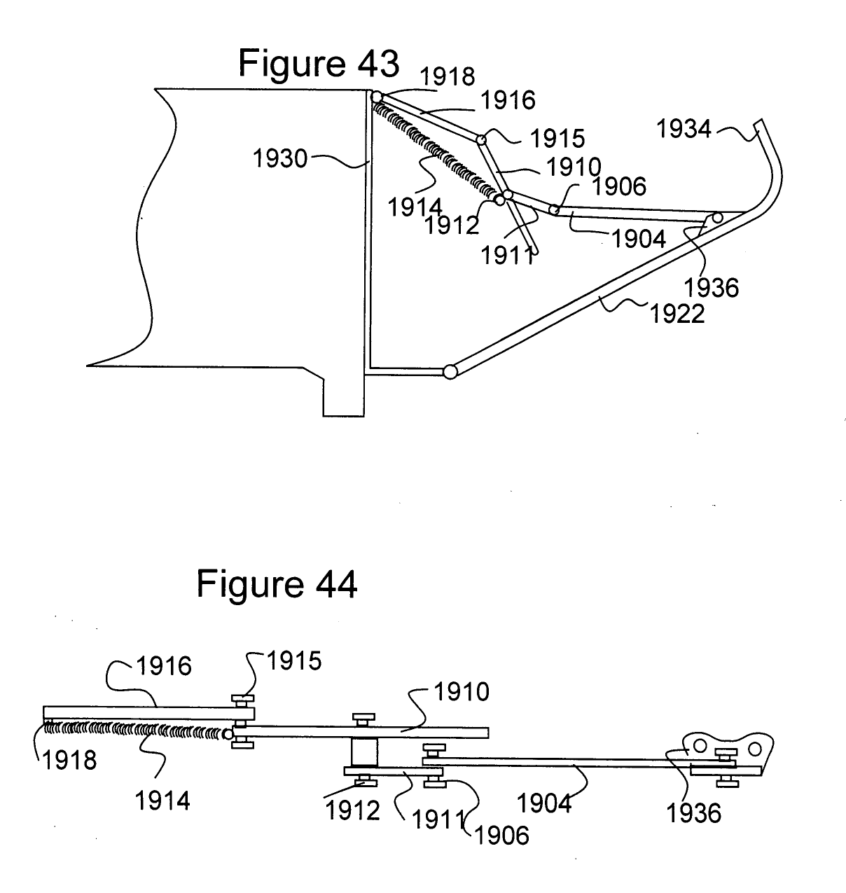

In FIGS. 42-44, pull down storage box 1900 is either permanently or removably secured to the front of caddy 1932. The box back panel 1930 can be provided with channels or flanges, as disclosed heretofore, which enables box 1900 to be easily mounted and removed. The floor 1928 and lid 1934 can have a width slightly greater than trays 1920 to enable front panel 1922 to close securely. The front panel 1922 is hinged to floor 1928 through use of hinge 1924. The trays 1920 are secured to multiple, hinged, support bars that enable multiple trays 1920 to vertically align, or stack, against back panel 1930.

The front bar 1904 is pivotally connected at one end to lid 1922 through use of bracket 1936. The other end of front bar 1904 is connected to short bar 1911 at pivot 1906. The short bar 1911 is pivotally connected at pivot 1912 to mid bar 1910, which in turn is connected to back bar 1916 at pivot 1915. The back bar 1916 is also pivotally connected to back panel 1930 at pivot 1918. A spring 1914 is affixed to back panel 1930, proximate pivot 1918, and to mid bar 1910, either at or proximate pivot 1912. The spring 1914 assists in bringing mid bar 1910 toward the back panel, thereby enabling e lid 1922 to close more easily.

In the closed position, back bar 1916 and mid bar 1910 lie inline, flush with back panel 1930 while front bar 1904 is placed adjacent back bar 1916. The trays 1920 should, therefore, be positioned to enable trays 1920 affixed to front bar 1904 to fit between the trays affixed to the back bar 1916.

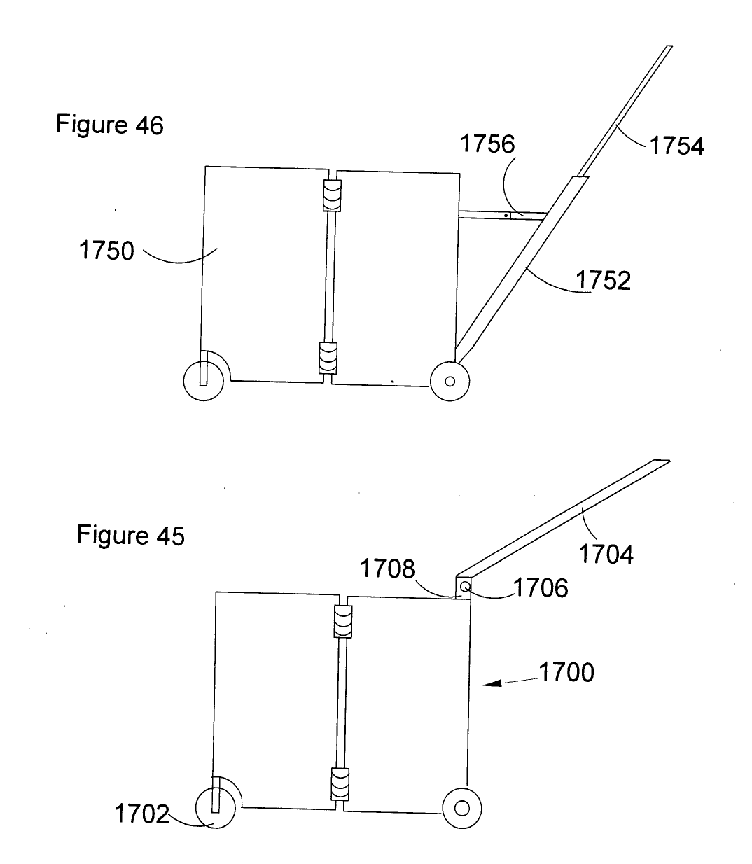

In FIG. 45, the caddy 1700 has pivotable front wheels 1702 have been added to enable the caddy 1700 to be easily pushed. In order to facilitate pushing caddy 1700, upper handle 1704 is rotated at joint 1706. The joint, or pivot 1706 enables upper handle 1704 to rotate in relation to bottom handle 1708 while still enabling handles 1704 to telescope into bottom handle 1708 when released from joint 1706. This pivoting motion can be accomplished through any means known in the art, such as used on bicycle seats, or any mechanism providing equivalent rotation. In FIG. 46, caddy 1750 has a second back panel 1752 that carries handles 1754. The second back panel 1752 is prevented from separating from caddy 1750 more than the predetermined distance by a connector 1756. The connector 1756 can be two rotating bars that collapse as second back panel 1752 is brought adjacent caddy 1750, or other connectors such as a chain, rope, etc. The connector 1756 can recess into either caddy 1750 or second back panel 1752 in order to enable second back panel 1752 to lie flush with caddy 1750. A locking member of a type known in the art, maintains second back panel 1752 in the vertical position.

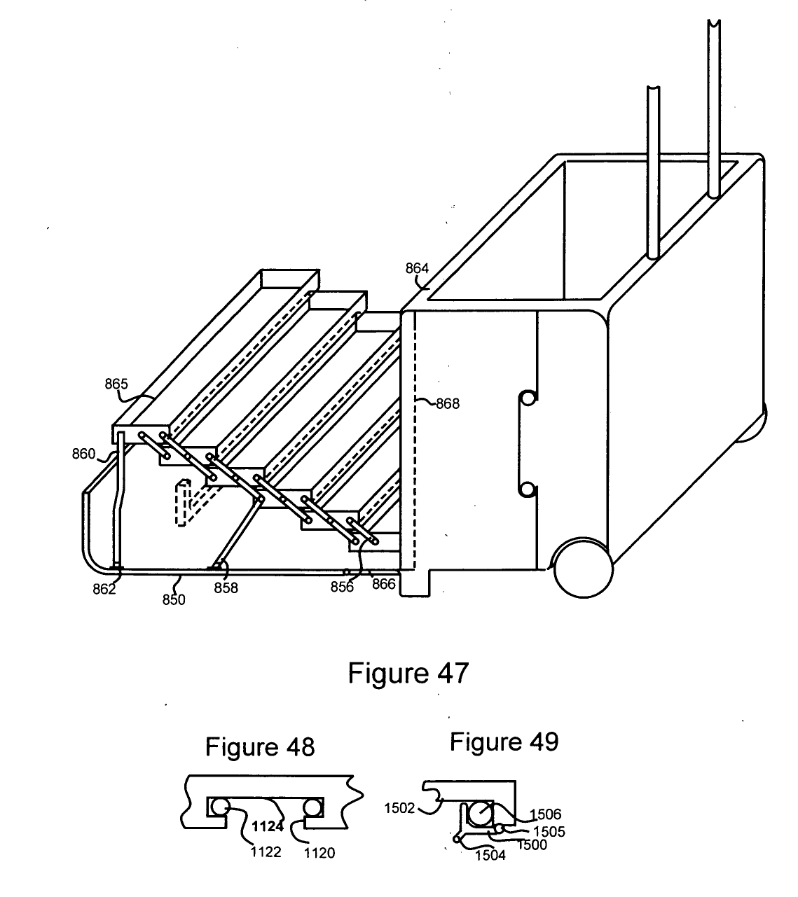

In FIG. 47 a fishing, or small tool, box 1850 is added to the back of a wheeled caddy. The box 1805 can be added either to the front or back of the caddy on a permanent basis or as a removable element. The box 1850 is provided with a hinged brace 1856 that folds into box casing 1858 as lid 1854 is closed. The trays 1852 rotate on brace 1856 during opening and closing to enable the contents to be maintained within the trays. The box 1850 can be sized to either take the maximum amount of space available on the caddy or can be a partial unit. In the illustrations herein, box 1850 is illustrated on the back of the caddy, however box 1850 can also be placed on either the front or front and back of the caddy. The trays 1852 should be spaced to permit trays 1852 to nestle within one another to permit lid 1854 to close. The pull down trays are known in the fishing box art and modification of the design will be obvious to those skilled in the art.

In FIG. 48, there is an alternate design for receiving the handles 1122 within the top caddy. Rather that the previously disclosed cutouts of caddy 820, the receiving area is provided with flanges 1120 that are parallel, and spaced from, back wall 1124. Alternatively, flanges 1120 can be replaced with a secondary wall to form a channel to receive handles 1122. It should be noted that the stationary wall, either partial or complete, will only be applicable for use with handles that do not have the plastic coated grip. The grip, commonly used in the art, extends the diameter of the handle grip beyond that of the vertical, telescoping bars. Therefore, when flanges 1120 are spaced a sufficient distance from back wall 1124 to receive the handle grip, back wall 1124 to flange 1120 distance is too great and permits movement between the caddy and handles 1122. To prevent lateral movement of the caddy, the distance between back wall 1124 and flanges 1120 much be only slightly greater than the diameter of the handles 1122.

An additional method of maintaining the top caddy in place and adjacent the handles 1506 is illustrated in FIG. 49 wherein clip 1500, rotating around hinge or pivot 1505, locks the top caddy to handles 1506. In this embodiment, clip 1500 is provided with a handle 1504 to facilitate opening and the locking mechanism is internal at the connection between caddy 1502 and clip 1500. Other clip designs will be apparent to those skilled in the art.

In FIGS. 50-52 an alternate method is shown for storing the two piece file holders 120 illustrated in FIGS. 11, 12, as well as the one piece file holder 400 of FIGS. 9, 33 and 34. The hanger insert 1000 is illustrated in FIG. 50 without the retaining bracket 1020 in place. The insert 1000 is designed with two receiving slots 1002 and 1004, each of which is “stepped” down from an upper platform 1006 and 1008 to a lower platform 1010 and 1012. Dividing receiving slot 1002 from slot 1004 is a brace 1014 that has a notch 1016. Within notch 1016 is a protrusion 1017 that has a height less than that of brace 1014. The hanger insert 1000 is able to accommodate the two piece file holders 120 and the one piece holder 400 because of the stepped down from the upper platform 1006 and 1008 to the lower platform 1010 and 1012. For convenience the interaction between the file holders 120 and 420 will be described in relation to only receiving slot 1002, as the units are mirror images and describing both would be redundant.

When two-piece file holders 120 are placed into insert 1000, caddy portion 122 is placed in upper platform 1006 and file portion 124 in lower platform 1010. The dimensioning between upper platform 1006 and lower platform 1010 can be about the distance from top plate 127 to the base of file portion 124 to enable file holders 120 to sit flush on platforms 1006 and 1010. The dimensioning of upper platform 1006 and lower platform 1010 can be such that caddy portion 122 and file portion 124 of file holders 120 can interlock, as illustrated in FIG. 12, while seated within receiving slot 1002. However, in the event the design of the caddy and holders is such that this depth cannot be achieved, caddy portion 122 and file portion 124 can be slid in the partially locked position to reduce the depth.

The hanging file folder holder 400 of FIG. 18 is dimensioned to be received within receiving slot 1002 in the same manner as described above. The upper portion of body 404 is placed on upper platform 1006 while lower portion of body 404, designed to receive the file holders, is resting on lower platform 1010. When designing the receiving slots 1002 and 1004 to receive either two-piece holders 120 or single piece holder 400, the depth of the single piece holder 400 must be considered with greater care than that of two-piece holder 120 as there is no flexibility with the single piece. When the file folder holders 670 of FIGS. 33 and 34 are used, the top platform 1006 can be designed to accommodate the curvature of the back support 672.

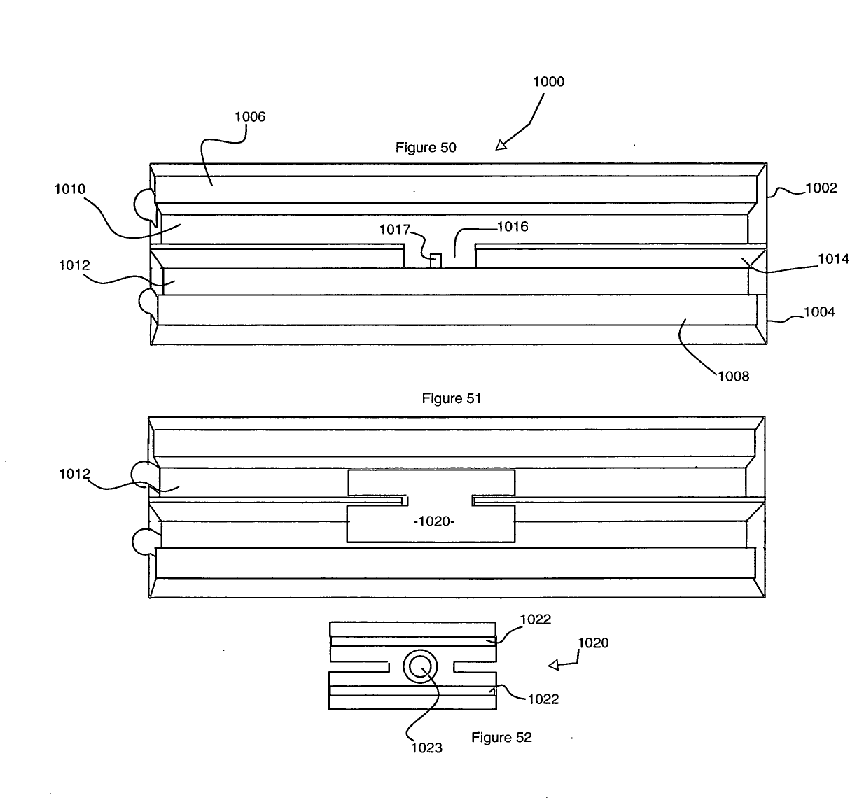

To maintain file holders 120 and 400 within insert 1000, a retaining bracket 1020, as shown in FIGS. 51 and 52, is snapped into place. The underside of the retaining bracket 1020 is illustrated in FIG. 52 wherein guides 1022 and receiving hole 1023 can be seen. The guides 1022 are dimensioned to fit within the U of the file-receiving portion of the holder. The width and placement of guides 1022 can be dimensioned to create a friction fit between the file holder and either the center brace 1014 or the wall of upper platform 1006 or 1008. The receiving hole 1023 is dimensioned to be removably affixed to protrusion 1017 through use of a snap fit, a release button or other means known in the art. The retaining bracket 1020 maintains file holders 120 and 400 within receiving slots 1002 and 1004 when the caddy is in the folded position.

Alternatively, the center brace 1014 can extend along the entire length of the hanger insert 1000 and the retaining bracket 1020 eliminated.

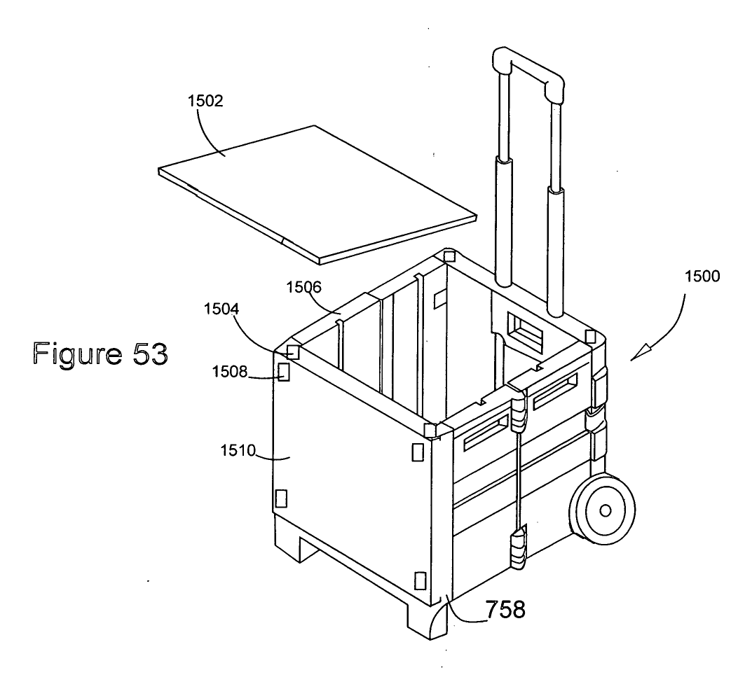

In FIG. 53, the caddy 1500 has a removable lid 1502 that is secured to the top edge 1506 through four magnets 1504. The opposing magnet is placed on the underside of the lid 1502. The magnets 1504 illustrated herein are small magnets placed at each corner, however full magnetic strips can be applied to the length and width of the top edge 1506 and to the underside of the lid 1502. In this embodiment additional magnets 1508 have been added to the corners of the front panel 1510 to enable the lid 1502 to be “stored” on the front of the caddy 1500. It should be noted the magnets 1504 and 1508 can also be replaced with snap locks, Velcro□, plastic snap in fasteners, separable hinges, such as in FIG. 34, or any other securing method that enables the lid 1502 to be easily, and quickly, opened or removed from the caddy 1500.

It should be noted that the caddies can be of any size that is convenient for end use. A height of six (6) inches may be appropriate for transporting lab beakers while a height of two (2) feet would be appropriate for camping. Further, the handle height can be adjusted to enable any number of caddies to be stacked.

### BROAD SCOPE OF THE INVENTION

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.”

In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example”.

What is claimed is:

1. In a collapsible wheeled caddy having a plurality of panels, including a front panel, a back panel, a first pair of vertically hinged side panels, a second pair of vertically hinged side panels; a first pair of wheels proximate said back panel; a hinged bottom panel; and retractable handles within said back panel, said caddy having an outer periphery and an open rim, the improvement comprising:
a removable lid, said removable lid having a first side, a second side and a periphery approximately equal to at least a portion of said outer periphery of said caddy,
a first securing mechanism, said first securing mechanism being affixed to said lid, and
a second securing mechanism, said second securing mechanism being affixed to at least a portion of said open rim and being positioned to receive said first securing mechanism.

2. The caddy of claim 1 wherein said first securing mechanism and said second securing mechanism are magnets.

3. The caddy of claim 1 wherein said first securing mechanism and said second securing mechanism are hook and loop fasteners.

4. The caddy of claim 1 wherein said first securing mechanism and said second securing mechanism are separable hinges, said hinges having a rotation of at least 270 degrees.

5. The caddy of claim 1 wherein said first securing mechanism is at least one snap lock and said second securing mechanism is at least one snap lock receiving area.

6. The caddy of claim 5 wherein said at least one snap lock is rotatable within said snap lock receiving areas to enable said lid to rotate at least 270 degrees.

7. The caddy of claim 1 wherein said first securing mechanism is at least one snap fastener and said second securing mechanism is at least one snap fastener receiving hole.

8. The caddy of claim 1 further comprising a third securing mechanism, said third set of securing mechanism being affixed to at least one of said plurality of panels and positioned to receive said lid removed from said rim and said first securing mechanism.

9. The caddy of claim 8 wherein said third securing mechanism is magnets.

10. The caddy of claim 8 wherein said third securing mechanism is a hook and loop fastener.

11. The caddy of claim 1 wherein said lid further comprises at least one arc, said at least one arc being positioned in said lid edge and dimensioned to receive said retractable handles when said lid is in a closed position.

12. The caddy of claim 1 wherein said removable lid is removably secured to one of said front panel or said back panel.

13. The caddy of claim 1 wherein at least one of said front panel and said back panel further comprise a pair of opposing L-shaped lips, said L-shaped lips creating a channel to receive said lid.

14. The caddy of claim 1 wherein said removable lid further comprises at least one storage compartment.

15. The caddy of claim 1 further comprising at least one single piece hanger, said hanger being able to be secured to opposing panels of said wheeled caddy and having:
at least one back plate, said at least one back plate being configured to lie adjacent to an exterior side of a panel,
a top plate, said top plate being at right angles to said back plate and dimensioned to be received by said opposing panels,
a front plate, said front plate being at right angles to said top plate and configured to lie adjacent to an interior side of said panel,
a connecting plate, said connecting plate being at right angles to said front plate, and
a receiving rim, said receiving rim being at right angles to said connecting plate to form a ledge for hanging objects.

16. The caddy of claim 15 wherein each of said at least one back plate has a receiving area to accommodate hinges on said first pair of vertically hinged side panels and said second pair of vertically hinged side panels.

17. The caddy of claim 16 wherein said receiving area is an open area within said at least one back plate.

18. The caddy of claim 16 wherein said receiving area is a curve in said back plate.

19. The caddy of claim 15 further comprising multiple back plates.

20. The caddy of claim 15 further comprising end plates.

21. The caddy of claim 15 wherein at least one of said plurality of panels has at least one recessed area, said at least one recessed area being dimensioned to receive and retain said at least one hanger.

22. The caddy of claim 21 wherein said at least one recess area has a recess rim, at least one first platform and at least one second platform, a distance from said recess rim to said at least one second platform being greater than a distance from said recess rim to said at least one first platform.

23. The caddy of claim 21 further comprising at least one brace, each said at least one brace dividing each of said at least one recess area.

24. The caddy of claim 21 further comprising at lease one retaining bracket, said at least one retaining bracket maintaining said hangers within said at least one recess area.

25. The caddy of claim 23 wherein said at least one brace has a notch and a protrusion with said notch, said protrusion having a height less than said at least one brace.

26. The caddy of claim 25 further comprising a retaining bracket, said retaining bracket having a receiving hole and guides, said receiving hole interacting with said protrusion and said guides being dimensioned to create a friction fit to maintain said hangers within said recess.

27. In a collapsible wheeled caddy having a plurality of panels, including a front panel, a back panel, a first pair of vertically hinged side panels, a second pair of vertically hinged side panels; a first pair of wheels proximate said back panel; a hinged bottom panel; and retractable handles within said back panel, said caddy having an outer periphery and an open rim, the improvement comprising:
at least one single piece hanger, said hanger being removably secured to opposing panels of said wheeled caddy and having:
at least one back plate, said at least one back plate being configured to lie adjacent to an exterior side of a panel,
a top plate, said top plate being at right angles to said back plate, and
a front plate, said front plate being at right angles to said top plate and being configured to lie adjacent to an interior side of said panel,
a connecting plate, said connecting plate being at right angles to said front plate, and
a receiving rim, said receiving rim being at right angles to said connecting plate to form a ledge,
wherein said connecting plate and said receiving rim provide a L-shaped bracket for hanging objects and said dimensioning between said front plate and said back plate fit over an edge of said panel, maintaining said hanger on said edge.

28. The caddy of claim 27 wherein said at least one back plate has a receiving area to accommodate hinges on said first pair of vertically hinged side panels and said second pair of vertically hinged side panels.

29. The caddy of claim 28 wherein said receiving area is an open area within said at least one back plate.

30. The caddy of claim 28 wherein said receiving area is a curve in said back plate.

31. The caddy of claim 27 further comprising multiple back plates.

32. The caddy of claim 27 further comprising end plates.

33. The caddy of claim 32 wherein said end plates are removable.

34. The caddy of claim 27 wherein at least one of said plurality of panels has at least one recessed area, said at least one recessed area being dimensioned to receive and retain said at least one hanger.

35. The caddy of claim 27 wherein said at least one recess area has at least one recess rim, at least one first platform and at least one second platform, a distance from said at least one recess rim to said at least one second platform being greater than a distance from said at least one recess rim to said at least one first platform.

36. The caddy of claim 27 further comprising at least one brace, each said at least one brace dividing each of said at least one recess area.

37. The caddy of claim 27 further comprising a retaining bracket, said retaining bracket maintain said hangers within each of said at least one recess area.

38. The caddy of claim 27 wherein said at least one brace has a notch and a protrusion with said notch, said protrusion having a height less than said at least one center brace.

39. The caddy of claim 38 further comprising a retaining bracket, said retaining bracket having a receiving hole and guides, said receiving hole interacting with said center protrusion and said guides being dimensioned to create a friction fit to maintain said hangers within said recess.
